(19) United States
(12) Patent Application Publication
(10) Pub. No.: US 2012/0167790 A1
(43) Pub. Date: Jul. 5, 2012

(54) OFFSET PRINTING METHOD AND APPARATUS

(76) Inventors: Shuntaro Suzuki, Yokohama-shi (JP); Keiko Nakamura, Yokohama-shi (JP); Kengo Matsuo, Yokohama-shi (JP); Norihito Kawaguchi, Yokohama-shi (JP)

(21) Appl. No.: 13/395,261

(22) PCT Filed: Aug. 31, 2010
(86) PCT No.: PCT/JP2010/064801

§ 371 Date: Mar. 9, 2012

(30) Foreign Application Priority Data
Sep. 9, 2009 (JP) 2009-208717

(51) Int. Cl. B41F 3/34

(52) U.S. Cl. 101/217; 101/492

(57) ABSTRACT

In this offset printing apparatus, a plate table (4) and a substrate table (6) are provided in a manner capable of traveling on guide rails (2) that are provided on a trestle (1). A transfer mechanism portion (9) that is provided with a blanket roll (10), lift actuators (13) of the blanket roll, a height sensor (14) of the blanket roll, and a pressure sensor (15) that detects the contact pressure of the blanket roll with respect to the plate (3) and the substrate (5) is provided at a position corresponding to the middle portion in the longitudinal direction of the guide rails (2). Also, a controller controls the lift actuators (13) so that the contact pressure that is detected by the pressure sensor (15) when the blanket roll (10) is brought into contact with the plate (3) and the substrate (5) becomes a predetermined value. Making uniform the contact pressure when performing transfer from the plate (3) to the blanket roll (10), and the contact pressure when performing retransfer from the blanket roll (10) to the substrate (5), makes the deformation amount of the contact portion with the plate (3) and the substrate (5) uniform, and equalizes the circumferential speed. As a result, it is possible to improve the printing accuracy.

### TECHNICAL FIELD

The present invention relates to an offset printing method and apparatus used for performing fine printing on a print target with high printing accuracy, when forming an electrode pattern on a substrate by printing.

Priority is claimed on Japanese Patent Application No. 2009-208717, filed Sep. 9, 2009, the content of which is incorporated herein by reference.

### BACKGROUND ART

Offset printing is one type of printing technique, and among these, in offset printing that uses intaglio, there is known a method that, after once transferring ink to a rolling blanket roll from an inked, engraved plate (reception), by performing the retransfer (printing) of the ink to the print target by the blanket roll, can print the print pattern of the aforementioned engraved plate with high reproducibility on the surface of the print target.

In recent years, as a means of forming an electrode pattern such as of a liquid crystal display (conductive pattern) on a required substrate, instead of fine processing such as etching of a metal vapor-deposited film, there has been provided a formation method that prints the electrode pattern on a substrate using a printing technique that uses a conductive paste as the printing ink, for example, intaglio offset printing technology (for example, refer to Patent Document 1 and Patent Document 2).

In the case of forming the electrode pattern such as of the liquid crystal display on the substrate, as the width of an electrode, for example a fine one of around 10 μm has been required. Furthermore, in the case of forming a plurality of electrode patterns in a superimposed manner on a substrate, overprinting of the electrode patterns is performed as a substitute for a plate, however, when the print position shifts, the electrode pattern collapses. For that reason, although the precision varies somewhat depending on the print target, in a fine electrode pattern in which the electrode width is made to be around 10 μm, restricting overlap misalignment to several μm is sometimes required. Accordingly, for the printing of an electrode pattern on a substrate, a high printing accuracy is required compared to normal intaglio offset printing that prints text or images on paper and the like.

Conventionally, as one of the methods provided for increasing the printing accuracy of intaglio offset printing, there is for example the following method. The offset printer that is used in this method is provided with a moving table on which an intaglio and a work that serves as the print target are held on the upper surface, a blanket roll (rotating blanket) for transfer printing that is disposed above the moving table, drive mechanisms that independently drive the moving table and the blanket roll, and a numerical control controller that independently controls the drive mechanisms for the moving table and for the blanket roll. The movement of the moving table that holds the intaglio and the work, and the rotating of the blanket roll are independently operated, and as a result of an operator fine tuning by manual input the circumferential speed of the blanket roll, it is possible to increase the accuracy of the transfer from the intaglio the blanket roll (reception) and the retransfer from the blanket roll to the work (printing) (for example, refer to Patent Document 3).

Also, as another method for increasing the printing accuracy of offset printing, there is for example the following method. The offset printer that is used in this method is provided with a roller (blanket roll) that has a cylindrical abutting portion (bearer roll), and a main body that has a planar abutting portion that supports a planar plate-like body and abuts the cylindrical abutting portion. Furthermore, while moving the roller and the plate-like body relatively parallel, together with the cylindrical abutting portion abutting the planar abutting portion, ink is transferred between the roller and a plate serving as a plate-like body (master plate) or a substrate that serves as the print target (work plate). In this printer, it is proposed that a contact force adjustment means be provided that adjusts the contact force between the cylindrical abutting portion and the planar abutting portion.

In a printer that has the aforementioned structure, by adjusting the contact force between the cylindrical abutting portion and the planar abutting portion with the contact force adjustment means, the contact force is adjusted. Then, the degree to which the contact portion of the cylindrical abutting portion deforms so as to follow the planar shape of the planar abutting portion changes, whereby the curvature radius of the contact portion of this cylindrical abutting portion changes, and so the apparent diameter increases or decreases. For that reason, even in the case of the same parallel movement amount, it is possible to change the angle of rotation of the roller. As a result, it is possible to perform registration of the angular position of the roller with respect to the plate or substrate as the plate-like body that is supported by the main body, that is, the printing position with high accuracy (for example, refer to Patent Document 4).

Also, one of the conditions for improving the printing accuracy in offset printing includes making uniform the printing pressure when contacting the blanket roll with the plate in order to perform the transfer (reception) process, or when contacting the blanket roll with the substrate that serves as the print target in order to perform the retransfer (printing) process. However, the surface portion of the circumferential wall of the blanket roll is formed with a material that has a required amount of resiliency, such as rubber. For that reason, when the blanket roll is pressed with a required pressure against a plate or a substrate that is the print target, the contact portion flexes along the surface of the plate or substrate, and as a result, once adsorbs ink from the plate during the aforementioned transfer (reception) process, and thereafter the ink absorption/transfer characteristic of the blanket roll when transferring the adsorbed ink during the retransfer (printing) process ends up relying on the deformation amount of the portion that makes contact with the substrate serving as the plate or print target, on the surface portion of the blanket roll.

Also, in relation to an apparatus that forms a laminate on the external circumference of a laminated drum, the position of the print portion for performing printing on the sheet that is wrapped on the outer circumference of the laminated drum, moving along the thickness direction in correspondence with the change in the thickness of the outer circumference of the laminated drum has been conventionally provided. As the aforementioned correspondence to the change of thickness, in addition to a method that overlaps the thickness per one layer that is set in advance by the number of times of lamination, a method is also shown that measures in real time the distance change with the outer circumference portion of the laminate drum, using a distance measurement sensor that is arranged on a straight line that is parallel win the movement direction of the printing portion and passes through the rotational center of a laminate drum (for example, refer to Patent Document 5).

### PRIOR ART DOCUMENTS

### Patent Documents

[Patent Document 1] Japanese Patent No. 2797567

[Patent Document 2] Japanese Patent No. 3904433

[Patent Document 3] Japanese Unexamined Patent Application, Publication No. 2000-272079

[Patent Document 4] Japanese Unexamined Patent Application, Publication No. 2006-142764

[Patent Document 5] Japanese Unexamined Patent Application, Publication No. 2005-183429

Since the surface of the circumferential wall of the blanket roll used in offset printing as mentioned above is formed with a material that is provided with the required elasticity, such as rubber, when pushed against a plate or a substrate that is the print target, the contact portion deforms along the surface of the plate or substrate. For this reason, there is the possibility that the adhesion state of ink when transferring the ink from a plate to the blanket roll, and when retransferring the ink from the blanket roll to the substrate may change due to the contact pressure between the plate and the blanket roll (printing pressure), and the contact pressure between the blanket roll and the substrate. As a result, for example, in the case of performing printing of a fine electrode pattern, there is a possibility that the thickness of the electrode to be printed as a fine line may not be constant.

Furthermore, when the contact portion of the blanket roll with the plate and substrate deforms along the surface of the plate or substrate by pushing the blanket roll against a plate or a substrate that is the print target with the required pressure with the required pressure applied, the roll diameter changes at this contact portion, and the circumferential speed of the blanket roll changes in accordance with the change in the roll diameter.

On the other hand, it is difficult to manufacture the substrate that is a print target with the thickness thereof being entirely the same. For that reason, some variation in the thickness dimension arises in each substrate.

Also, sometimes some variation may arise in the thickness of each plate, among a plurality of plates used for performing overprinting.

When a difference arises in the contact pressure in each substrate with the blanket roll due to a variation in the thickness of each substrate that is the print target, for example, even in the case of using the same plate, there is the possibility of the thickness of the electrode as a fine line of an electrode pattern that is printed on each substrate may not be uniform. Also, the print pattern that is printed on each substrate may not necessarily be constant, and there is the possibility that reproducibility may fall.

Furthermore, when a difference arises in the contact pressure in each plate with the blanket roll due to a variation in the thickness dimension of a plurality of plates used for performing overprinting, there is the possibility of the thickness of the electrode as a fine line of an electrode pattern that is formed by overprinting using the plurality of plates for a single substrate not being uniform, and of a misalignment may occur.

Moreover, due to the plate gradually abrading (wearing) as a result of being used for printing, it is necessary to exchange the plate at a required number of printings or printing time. In this case, when a variation occurs in the thickness dimension between the plate prior to replacing and the new plate after replacing, a difference may occur in the contact pressure with the blanket roll. As a result, around the time the plate is replaced, due to the thickness of the electrode as a fine line of the electrode pattern to be printed on a substrate changing, and the print pattern to be printed on the substrate changing, there is a possibility of reproducibility not being obtained.

In particular, in the case of a high printing accuracy being required for forming a fine print pattern such as an electrode pattern, due to changes in the contact pressure between the plate and the blanket roll, and changes in the contact pressure between the blanket roll and each substrate, the thickness of the fine lines that are printed may slightly change, and the print position may shift due to a change in the circumferential speed accompanying the slight change in the roll diameter of the blanket roll, whereby there is a possibility of becoming an obstacle when attaining the required print accuracy.

Note that in the method shown in Patent Document 3, although a concept is shown to adjust the circumferential speed of the blanket roll, it is necessary to adjust the circumferential speed of the blanket roll by manual input. Also, since the operator determines by vision from the print result whether or not the suitable circumferential speed of the blanket roll has been obtained, quantitative evaluation is difficult.

In Patent Document 4 is shown a concept of performing registration of the print position with high accuracy by adjusting the contact force (contact pressure) between the cylindrical abutting portion of the roller (blanket roll) and the planar abutting portion that is provided in the main body that supports the plate or substrate. However, there is no consideration given to making constant the contact pressure of the roller with respect to the plate, and the contact pressure of the roller with respect to each substrate in which the thickness dimension is not necessarily constant. For that reason, in the method that is shown in patent Document 4, it is not possible to eliminate the possibility of a difference arising between the contact pressure of the roller with the plate or substrate as described above. Also, due to the occurrence of a difference in the contact pressure when the roller makes contact with the plate or substrate, a difference occurs in the amount of change of the roller diameter of the contact portion with respect to the plate or each substrate, and due to the change in the circumferential speed of this contact portion, it is not possible to eliminate the problem of a drop in the printing accuracy and reproducibility with respect to each substrate. Furthermore, controlling the contact force (contact pressure) with the planar abutting portion that is provided in the main body that supports the plate or substrate in order to perform registration of the print position is not valid from the original object of making the print pattern by the offset printing uniform.

Also, when performing offset printing by bringing the blanket roll into contact from above with the plate or substrate serving as the print target in turn, even if the height of the blanket roll that is brought into contact with the plate or substrate serving as the print target is maintained constant, the printing pressure from the blanket roll to the plate or substrate serving as the print target is not necessarily uniform.

Reasons for the printing pressure not becoming uniform include cases of the thickness dimension of the plate and the substrate differing, cases of the thickness of the substrate differing for each lot, cases of the thickness dimension of the substrate not necessarily being uniform even within the same lot, cases of the plate having become worn during the printing process, cases of the plate being replaced in the event of changing the print pattern, but a difference occurring in the thickness dimension of the plate before and after the replacement, cases of the thickness dimension not necessarily being uniform even within the plane of a single plate or print target, and moreover cases of the rotational center of the blanket roll being eccentric in relation to the processing accuracy, and the like.

A measure for making uniform the printing pressure of the blanket roll and the plate or substrate that is the print object is considered to be, when the blanket roll is brought into contact with the plate or substrate that is the print object, making constant the printing pressure by directly measuring the printing pressure with a load cell or the like, and performing feedback control on the rising and falling operation of the blanket roll in correspondence with the magnitude of the measurement value of the printing pressure. However, since the measurement time in this method is comparatively long, a limit arises in the speeding up of the printing speed.

Note that in the printer that is disclosed in Patent Document 4, as a result of adjusting the contact pressure between the bearer roll and the bearer rail by a contact force adjustment means in order to be able to perform registration of the printing position with high accuracy, the print pressure is not stable. For that reason, for example, in the case of performing printing of a fine electrode pattern, it becomes difficult to print the thickness of fine line electrodes in a uniform manner.

By applying a method that detects in real time changes in the thickness of the outer circumferential portion of the laminated drum by measuring the distance change with the outer circumference portion of the laminated drum using a distance measurement sensor that is arranged on a straight line that is parallel with the movement direction of the printing portion and passes through the rotational center of the laminated drum, to detecting the thickness change of a print object such as a planar plate or substrate that is brought into contact with a blanket roll that is in the offset printing apparatus as shown in Patent Document 4, it is necessary to install a distance measurement sensor at the contact point between the blanket roll and the planar plate or print object. For that reason, it is necessary to protrude the planar plate or print object outward beyond the blanket roll in the roll axis direction to install a distance measurement sensor in correspondence with that protruding portion. However, it is not realistic to use a plate or print object that protrudes outward beyond the blanket roll in the roll axis direction.

Moreover, even if for example the planar plate or print target is made to protrude outward beyond the blanket roll in the roll axis direction, and the thickness change in that protruded amount is measured, from the measurement result, it is not possible to detect a thickness change in the roll axis direction of the portion that is in actual contact with the blanket roll in the planar plate or print target.

The present invention provides an offset printing method and apparatus that, even if a print target in the manner of a substrate does not necessarily have a constant thickness dimension, can print with high reproducibility on each print target a print pattern in which the thickness of the thin line is uniform and has neither a blur nor a blot, and can increase the printing accuracy; and even if in the case that a plurality of plates that are used for overprinting do not have a constant thickness dimension, and even if in the case that the plates before and after replacement do not have a constant thickness dimension during replacement of the plates, it is possible to print a print pattern with neither a blur nor a blot in a thin line with a high reproducibility, and possible to increase the print accuracy; and thereby can perform fine printing such as of an electrode pattern with high accuracy, and can suppress misalignment to a micrometer order even in the case of overprinting.

Also, the present invention provides an offset printing method and apparatus that, in the case of the thickness dimension of a plate and the print target such as a substrate differing, the thickness of the print target differing for each lot, the thickness dimension of the substrate not necessarily being uniform even within the same lot, and furthermore in relation to the processing accuracy even if the rotational center of the blanket roll is eccentric, while bringing the blanket roll into contact with the plate, and while bringing the blanket roll into contact with the print target, can maintain a uniform printing pressure and can increase the printing accuracy of the print pattern that is printed on the print target via the blanket roll from the plate, and thereby can perform with high accuracy fine printing such as an electrode pattern, and that is advantageous in the case of performing printing at high speed.

### DISCLOSURE OF THE INVENTION

The first invention according to the present invention is an offset printing method that, by bringing a blanket roll that moves up and down by lift actuators into contact from above with a plate that is held on a plate table that travels on guide rails provided on a trestle, and next by bringing the blanket roll into contact from above with a print target that is held on a print target table that travels on the guide rails, performs a transfer from the plate to the blanket roll, and a retransfer from the blanket roll to the print target, wherein the offset printing method controls a vertical motion of the blanket roll by the lift actuators so that the contact pressure while the blanket roll makes contact with the plate that is held on the plate table, and the contact pressure while the blanket roll makes contact with the print target that is held on the print target table are respectively kept constant at a predetermined value.

Also, the second invention according to the present invention is an offset printing method that, by bringing a blanket roll that moves up and down by lift actuators into contact from above with a plate that is held on a plate table that travels on guide rails provided on a trestle, and next by bringing the blanket roll into contact from above with a print target that is held on a print target table that travels on the guide rails, performs a transfer from the plate to the blanket roll, and a retransfer from the blanket roll to the print target, wherein the offset printing method, after controlling a vertical motion of the blanket roll by the lift actuators so that the contact pressure when the blanket roll starts to make contact with the plate that is held on the plate table becomes a predetermined value, keeps the height of the blanket roll constant while the blanket roll is in contact with the plate that is held on the plate table, and moreover, after controlling the vertical motion of the blanket roll by the lift actuators so that the contact pressure when the blanket roll starts to make contact with the print target that is held on the print target table becomes a predetermined value, keeps the height of the blanket roll constant while the blanket roll is in contact with the print target that is held on the print target table.

Furthermore, the third invention according to the present invention is an offset printing apparatus that is provided with a plate table and a print target table that travel on guide rails provided on a trestle and that, by successively bringing a blanket roll that moves up and down by lift actuators into contact from above with a plate that is held on the plate table and a print target that is held on the print target table, performs transfer from the plate to the blanket roll, and retransfer from the blanket roll to the print target, wherein the offset printing apparatus is provided with a pressure sensor that detects the contact pressure of the blanket roll that moves up and down by the lift actuators with respect to the plate and the print target, and moreover provided with a controller that has a function that issues commands to the lift actuators so that while performing transfer between the blanket roll and the plate, and while performing retransfer between the blanket roll and the print target, the contact pressure that is respectively input from the pressure sensor is kept constant at a predetermined value.

Furthermore, the fourth invention according to the present invention is an offset printing apparatus that is provided with a plate table and a print target table that travel on guide rails provided on a trestle and that, by successively bringing a blanket roll that moves up and down by lift actuators into contact from above with a plate that is held on the plate table and a print target that is held on the print target table, performs transfer from the plate to the blanket roll, and retransfer from the blanket roll to the print target, wherein the offset printing apparatus is provided with a height sensor that detects the height of the blanket roll that moves up and down by the lift actuators, and a pressure sensor that detects the contact pressure of the blanket roll with respect to the plate and the print target, and moreover, provided with a controller that has a function that issues commands to the lift actuators so that, when starting transfer between the blanket roll and the plate, the contact pressure that is input from the pressure sensor becomes a predetermined value, and issues commands to the lift actuators based on the input from the height sensor so that the height of the blanket roll when the contact pressure that has been input from the pressure sensor has become a predetermined value is maintained while performing transfer between the blanket roll and the plate, and a function that issues commands to the lift actuators so that, when starting retransfer between the blanket roll and the print target, the contact pressure that is input from the pressure sensor becomes a predetermined value, and issues commands to the lift actuators based on the input from the height sensor so that the height of the blanket roll when the contact pressure that has been input from the pressure sensor has become a predetermined value is maintained while performing retransfer between the blanket roll and the print target.

Also, in the aforementioned offset printing apparatus, preferably the controller has a function that, in the case of eccentricity having arisen in the blanket roll when issuing commands to the lift actuators based on the input from the height sensor so that the height of the blanket roll when the contact pressure that has been input from the pressure sensor has become the respective predetermined value is maintained while performing transfer between the blanket roll and the plate, and while performing transfer between the blanket roll and the print target, adds a correction to the height that the blanket roll should be maintained at based on the eccentricity amount of the blanket roll.

Also, the fifth invention according to the present invention is an offset printing method that, by bringing a blanket roll that moves up and down by lift actuators, in the state of being rotated by a rotation drive motor, into contact from above with a plate that is held on a moving table that travels on guide rails on a trestle, and next by bringing the blanket roll into contact from above with a print target that is held on a moving table that travels on the guide rails, performs a transfer from the plate to the blanket roll, and a retransfer from the blanket roll to the print target, wherein the offset printing method, prior to the plate on the plate table or the print target on the print target table advancing to a position directly below the blanket roll, measures in advance the height of the surface of the plate on the plate table or the print target on the print target table with the upper surface of the trestle serving as a reference along the travel direction of the table during transfer, and next, when bringing the blanket roll into contact with the plate or the print target, controls the height on the trestle of the rotational center of the blanket roll to a height that is calculated by subtracting a predetermined target roll pressing amount from the sum of the height of the surface of the plate or print target that is measured in advance and the radius of the blanket roll.

Also, the sixth invention according to the present invention is an offset printing apparatus that, by successively bringing a blanket roll that moves up and down by lift actuators, in the state of being rotated by a rotation drive motor, into contact from above with a plate and a print target that are held on an individual or shared moving table that travels on guide rails on a trestle, performs a transfer from the plate to the blanket roll, and a retransfer from the blanket roll to the print target, wherein a distance measurement sensor for measuring the distance with the surface of the plate on the plate table or the print target on the print target table is provided more at a position on the upstream side in the table travel direction during transfer than the blanket roll, and moreover the offset printing apparatus is provided with a controller that has a function that computes and temporarily stores the surface height of the portion of the plate on the plate table or the print target on the print target table that is positioned directly below the distance measurement sensor with the upper surface of the trestle serving as a reference, based on a signal that is input from the distance measurement sensor, and a function that, at the point in time of the portion being positioned directly below the rotational center of the blanket roll and making contact with the blanket roll, issues commands to the lift actuators to make the height of the rotational center of the blanket roll on the trestle agree with a height that is calculated by subtracting a predetermined target roll pressing amount from the sum of the height of the portion on the surface of the plate on the plate table or the print target on the print target table that is measured in advance and the radius of the blanket roll

### Effects of the Invention

The present invention exhibits the following outstanding effects.

(1) According to the first and third inventions according to the present invention, since it is possible to make uniform at respective predetermined contact pressures the contact pressure when performing transfer of ink by bringing the blanket roll into contact with the plate, and the contact pressure when performing retransfer by bringing the blanket roll into contact with the print target, it is possible to make uniform the deformation amount of the contact portion when bringing the blanket roll into contact with the plate and the deformation amount of the contact portion when bringing the blanket roll into contact with the print target, respectively.

Accordingly, it is possible to make uniform the width of a thin line to be printed, and possible to make uniform the circumferential speed of the blanket roll when performing the transfer from the plate to the blanket roll, and the circumferential speed of the blanket roll when retransferring the ink from the blanket roll to the print target, respectively. Therefore, it is possible to increase the reproducibility of the print pattern to be printed from the plate to the print target via the blanket roll, and possible to accurately print a fine print pattern such as an electrode pattern on the print target.

(2) Also, it is possible to prevent variations in the contact pressure and circumferential speed of the blanket roll beforehand when performing retransfer on each print target, even if there is a variation in the thickness dimension of the print target that is held on the print target table. For that reason, it is possible to prevent variations in the print accuracy and reproducibility beforehand in each print target.

(3) Also, it is possible to prevent variations in the contact pressure and circumferential speed of the blanket roll with respect to each plate beforehand, even if there is a plurality of plates for performing overprinting, or a variation in the thickness dimension in each plate prior to exchanging or after exchanging when exchanging plates.

(4) Moreover, since it is possible to perform printing with high accuracy and reproducibility on the print target, it is possible to inhibit misalignment even in the case of overprinting a fine print pattern such as an electrode pattern on a print target. Therefore, it is advantageous to restricting misalignment to a micrometer order.

(5) According to the second and fourth invention of the present invention, after bringing the blanket roll into contact with the plate or print target and once controlling the contact pressure to a respective predetermined contact pressure, by maintaining the height of the blanket roll at the point in time of the contact pressure of the blanket roll being made the predetermined contact pressure, it is possible to bring it into contact with the plate or the print target in the state of the deformation amount of the contact portion when the blanket roll is brought into contact with the plate, and the deformation amount of the contact portion when the blanket roll is brought into contact with the print target are respectively made uniform.

Therefore, it is possible to obtain the same effect as the aforementioned (1), (2), (3) and (4).

(6) In the case of eccentricity having arisen in the blanket roll when the controller issues commands to the lift actuators based on the input from the height sensor so that the height of the blanket roll when the contact pressure that has been input from the pressure sensor has become the respective predetermined value is maintained while performing transfer between the blanket roll and the plate, and while performing transfer between the blanket roll and the print target, even if the blanket roll is eccentric by imparting a function that adds a correction to the height that the blanket roll should be maintained at based on the eccentric amount of the blanket roll, it is possible to perform transfer or retransfer between the plate or print target in the state of maintaining the deformation amount of the portion of the blanket roll in contact with the plate or print target at the deformation amount in the state of controlling the contact pressure by bringing the blanket roll into contact with the plate or print target to a once predetermined contact pressure, respectively.

Thereby, it is possible to increase the print accuracy even if the blanket roll is eccentric in the aforementioned manner.

(7) According to the fifth and sixth inventions according to the present invention, it is possible to always press the blanket roll against the plate or print target by a predetermined target roll pressing amount while performing the transfer (reception) process by bringing the blanket roll into contact with the plate, and while performing the retransfer (printing) process by bringing the blanket roll into contact with the print target. For that reason, it is possible to keep uniform the printing pressure that acts on the plate or print target from the blanket roll.

(8) Accordingly, it is possible to increase the printing accuracy of the print pattern to be printed from the plate to the print target via the blanket roll, and to perform fine printing such as of an electrode pattern with high accuracy.

(9) Moreover, control of the height of the blanket roll that is performed so that the pressing amount of the blanket roll with respect to the plate or substrate becomes the target roll pressing amount is performed based on the measurement result of the height of the surface of the plate or substrate that is measured in advance at the point in time of the plate on the plate table or the substrate on the substrate table being arranged more to the upstream side in the table travel direction during transfer than the rotational center of the blanket roll.

### BRIEF DESCRIPTION OF THE DRAWINGS

FIG. 1 is a schematic side view that shows an embodiment of the offset printing method and apparatus of the present invention.

FIG. 2 is a cross-sectional view that shows an enlargement of the transfer mechanism portion in the offset printing apparatus.

FIG. 3 is an arrow view in the A-A direction of FIG. 2.

FIG. 4 is a schematic drawing that shows the control configuration of the controller that is provided in the offset printing apparatus of FIG. 1.

FIG. 5 is a control block diagram in the case of controlling the height of the blanket roll by the controller of the offset printing apparatus of FIG. 1.

FIG. 6 is a control block diagram in the case of controlling the contact pressure of the blanket roll to be constant by the controller of the offset printing apparatus of FIG. 1.

FIG. 7A shows the initial state prior to transfer, by a schematic drawing that shows the transfer operation procedure of the transfer mechanism portion in the case of performing offset printing by the offset printing apparatus of FIG. 1.

FIG. 7B shows the state of having started rotation of the blanket roll and travel of the plate table in synchronization, by a schematic drawing that shows the transfer operation procedure of the transfer mechanism portion in the case of performing offset printing by the offset printing apparatus of FIG. 1.

FIG. 7C shows the state of the blanket roll having made contact with the plate, by a schematic drawing that shows the transfer operation procedure of the transfer mechanism portion in the case of performing offset printing by the offset printing apparatus of FIG. 1.

FIG. 8A shows the state of having controlled the contact pressure of the blanket roll with the plate to a predetermined pressure, by a schematic drawing that shows the operation following FIG. 7C of the transfer operation procedure in the transfer mechanism portion of the offset printing apparatus of FIG. 1.

FIG. 8B shows the state of the contact pressure over a range of the blanket roll being maintained at a predetermined pressure, by a schematic drawing that shows the operation following FIG. 7C of the transfer operation procedure in the transfer mechanism portion of the offset printing apparatus of FIG. 1.

FIG. 9A shows the state of the blanket roll that has been lifted to the retraction height, by a schematic drawing that shows the operation following FIG. 8B of the transfer operation procedure in the transfer mechanism portion of the offset printing apparatus of FIG. 1.

FIG. 9B shows the state of transfer being complete, by a schematic drawing that shows the operation following FIG. 8B of the transfer operation procedure in the transfer mechanism portion of the offset printing apparatus of FIG. 1.

FIG. 10A shows the state prior to starting inking of the plate, by a schematic side view that shows the inking apparatus of the offset printing apparatus of FIG. 1.

FIG. 10B shows the state of having started inking by bringing the ink-pushing blade and the ink-scraping blade into contact with the plate, by a schematic side view that shows the inking apparatus of the offset printing apparatus of FIG. 1.

FIG. 10C is a schematic side view that shows the ink-pushing blade and the ink-scraping blade of the inking apparatus of the offset printing apparatus of FIG. 1.

FIG. 11A shows the state of moving the plate table that holds the plate to the plate table standby area after being provided to the transfer of ink to the blanket roll, by a schematic side view that shows the inking apparatus of the offset printing apparatus of FIG. 1.

FIG. 11B shows the state of returning an ink pool on the plate to the end area toward the other end of the plate in the longitudinal direction of the guide rails, by the schematic side view that shows the inking apparatus of the offset printing apparatus of FIG. 1.

FIG. 12 shows another embodiment of the present invention, being a control block view of the case of performing roll height maintenance control that maintains the height of the blanket roll, upon completion of the control that makes constant the pressure of the blanket roll by the controller of the offset printing apparatus.

FIG. 13 is a drawing that shows the transfer operation in the case of performing the roll height maintenance control of FIG. 12.

FIG. 14 is a schematic side view that shows another embodiment of the offset printing method and apparatus of the present invention.

FIG. 15 is a partial sectional view that shows an enlargement of the transfer mechanism portion in the offset printing apparatus of FIG. 1.

FIG. 16 is an arrow view in the A1-A1 direction of FIG. 15.

FIG. 17 is an arrow view in the B-B direction of FIG. 16.

FIG. 18 is a side view that shows an enlargement of the contact portion of the blanket roll with the plate or print target.

FIG. 19 is a schematic view that shows the control constitution of the controller that is provided in the offset printing apparatus of FIG. 14.

FIG. 20 is a drawing that shows the outline of the surface height temporary storage table that the controller is provided with.

FIG. 21 is a control block view in the case of controlling the blanket roll height in the state of the blanket roll not brought into contact with the plate or substrate by the controller of the offset printing apparatus of FIG. 14.

FIG. 22 is a control block view in the case of pressing the blanket roll on the plate or substrate by the target roll pressing amount by the controller of the offset printing apparatus of FIG. 14.

FIG. 23A shows the initial state prior to transfer, by a schematic drawing that shows the transfer operation procedure of the transfer mechanism portion in the case of performing offset printing by the offset printing apparatus of FIG. 14.

FIG. 23B shows the state of having started rotation of the blanket roll and travel of the plate table in synchronization, by a schematic drawing that shows the transfer operation procedure of the transfer mechanism portion in the case of performing offset printing by the offset printing apparatus of FIG. 14.

FIG. 23C shows the state of the blanket roll having made contact with the plate, by a schematic drawing that shows the transfer operation procedure of the transfer mechanism portion in the case of performing offset printing by the offset printing apparatus of FIG. 14.

FIG. 24A shows the state of having controlled the height of the blanket roll so as to press by the predetermined target roll pressing amount the blanket roll over the transfer range, by a schematic drawing that shows the operation following FIG. 23C of the transfer operation procedure in the transfer mechanism portion of the offset printing apparatus of FIG. 14.

FIG. 24B shows the state of lifting the blanket roll to the retraction height, by a schematic drawing that shows the operation following FIG. 23C of the transfer operation procedure in the transfer mechanism portion of the offset printing apparatus of FIG. 14.

FIG. 24C shows the state of the transfer being complete, by a schematic drawing that shows the operation following FIG. 23C of the transfer operation procedure in the transfer mechanism portion of the offset printing apparatus of FIG. 14.

### BEST MODE FOR CARRYING OUT THE INVENTION

Hereinbelow, the embodiment for implementing the present invention shall be described with reference to the drawings.

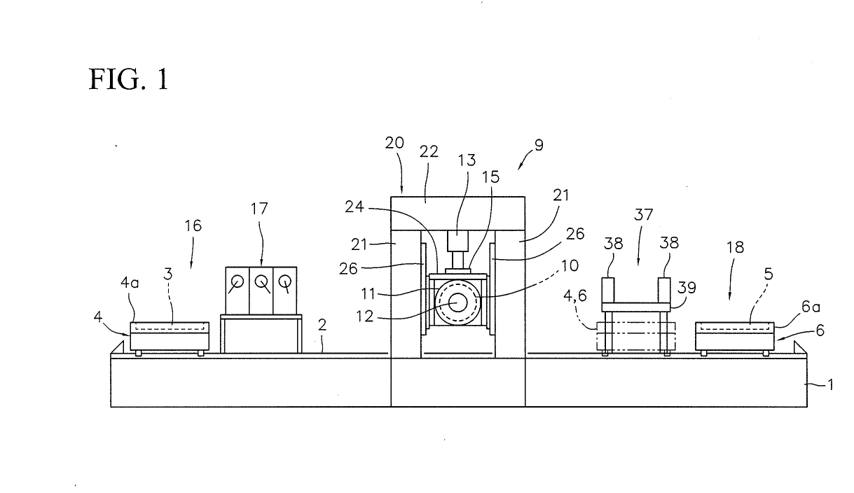

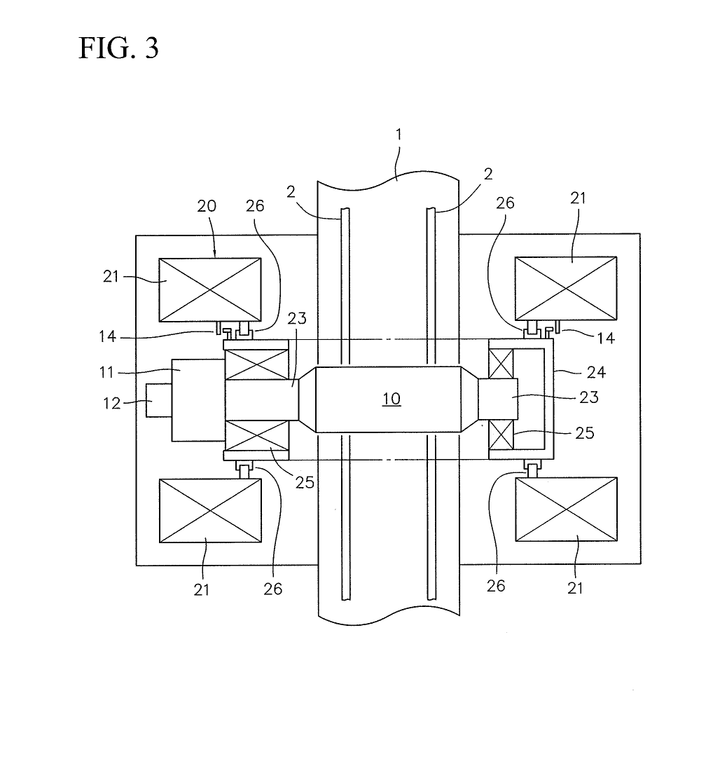

FIG. 1 through FIG. 11B show one aspect of the offset printing method and apparatus of the present invention, and has the following constitution.

That is, guide rails 2 that extend in one direction (X-axis direction), for example two guide rails 2 forming a pair, are provided on the upper side of a horizontal trestle 1. A plate table 4 that holds a plate 3 such as an intaglio on the upper surface portion, and a substrate table 6 serving as a print target table that holds a substrate 5 serving as a print target on the upper surface portion are arranged on the guide rails 2 in succession from one end side (left side in FIG. 1) of the guide rails 2 in the longitudinal direction. These tables 4 and 6 are slidably attached to the guide rails 2 via individual guide blocks 2a, and are capable of independently moving (traveling) along the guide rails 2 by individual drive units 7 such as a linear motor or the like.

Furthermore, it is possible to perform detection of the respective positions of the plate table 4 and the substrate table 6 along the longitudinal direction of the guide rails 2, that is, the absolute positions along the X-axis direction that have a predetermined point as a reference, by a common linear scale 8 that is provided on the trestle 1 parallel to the guide rails 2.

A transfer mechanism portion 9 is provided at a position that corresponds to the middle portion in the longitudinal direction of the guide rails 2 on the trestle 1. The transfer mechanism portion 9 is provided with a blanket roll 10 that is arranged above the guide rails 2 so as to extend in a direction that is perpendicular with the longitudinal direction of the guide rails 2 (Y-axis direction), and can be rotationally driven by a drive motor 11, an encoder 12 for detecting the rotational speed of the blanket roll 10 and the angular orientation in the circumferential direction, a lifting actuator 13 such as a jack or a ball screw mechanism for moving up and down the blanket roll 10 (the form of a jack is shown in the drawing), a height sensor 14 for detecting the height of the blanket roll 10, and a pressure sensor 15. The lifting actuator 13 moves the blanket roll 10 between a retracted height (retracted position) Ha that is a position in which the lower end portion of the peripheral wall surface of the blanket roll 10 is arranged at a position that is higher by a predetermined dimension than the upper surface of the tables 4 and 6, and a contact height (contact position) Hb that is a position in which the lower end portion of the peripheral wall surface of the blanket roll 10 is arranged at a height that corresponds to the upper surface of the tables 4 and 6. Also, when the blanket roll 10, which has been lowered to the contact height Hb by the lifting actuator 13, is bought into contact with the plate 3 that is held on the plate table 4 and the substrate 5 that is held on the substrate table 6 in the state of being arranged thereunder and pressed against them biased downward, the pressure sensor 15 detects the contact pressure between both.

Furthermore, a plate table standby area 16 for moving the plate table 4 to one end portion in the longitudinal direction of the guide rails 2 and placing it in standby is provided at a position on the trestle 1 corresponding to the one end portion of the guide rails 2 in the longitudinal direction. Also, an inking apparatus 17 for performing inking of the plate 3 that is held on the upper surface portion of the plate table 4 is provided between the plate table standby area 16 and the transfer mechanism unit 9 on the trestle 1.

A substrate installation area 18 for performing attachment of the substrate 5 for newly performing a print process on the upper surface portion of the substrate table 6, and performing removal of the substrate 5 after the print process is performed, in the state of the substrate table 6 being moved to the other end portion in the longitudinal direction of the guide rails 2 and placed in standby, is installed at a position on the trestle 1 corresponding to the other end portion in the longitudinal direction of the guide rails 2.

Moreover, it is provided with a controller (controller) 19 that issues commands to the individual drive units 7 of the plate table 4 and the substrate table 6, and the drive motor 11 of the blanket roll 10 and the lift actuator 13 of the transfer mechanism portion 9, based on a detection signal of the position relating to the longitudinal direction of the guide rails 2 of the plate table 4 and the substrate table 6 inputted from the linear scale 8, and the signal that is input by the encoder 12, the height sensor 14, and the pressure sensor 15 of the transfer mechanism unit 9. Then, the offset printing apparatus of the present invention is constituted with these members.

In detail, in the transfer mechanism portion 9, as shown in FIG. 1 to FIG. 3, two pillar members 21 which have the required height are provided so as to be separated by a required interval of the guide rails 2 in the longitudinal direction (X-axis direction) on both outer sides in the middle of the guide rails 2 in the longitudinal direction. Also, a beam member 22 that is arranged so as to cross the upper part of the middle portion of the guide rails 2 in the longitudinal direction connects the top portions of the pillar members 21, and with the pillar members 21 constitutes a gate-shaped frame 20. In the frame 20, both end portions of a roll housing 24, in which rotating shafts 23 at both ends of the blanket roll 10 are held in a freely rotating manner via a bearing 25, are attached to be capable of moving in the vertical direction via linear guides 26 that extend in the vertical direction, between the two pillar members 21 that are arranged on the X-axis direction on the outer side of the guide rails 2.

Furthermore, the lift actuator 13 and the pressure sensor 15 are respectively attached so as to intervene in series between two positions that are spaced apart by a required interval in the axial center direction of the blanket roll 10 in the roll housing 24, for example, two positions that mostly correspond to both end portions in the axial center direction of the blanket roll 10, and two positions of the beam member 22 of the frame 20 respectively corresponding to each position.

Furthermore, as the height sensor 14 of the blanket roll 10, for example, the height sensor 14 on a linear scale in the vertical direction is provided between the required position at both end portions of the roll housing 24 and the required position of the respectively corresponding pillar members 21 in the frame 20. Then, it is possible to detect the vertical position of the roll housing 24 by each height sensor 14, and possible to indirectly perform detection of the height of the blanket roll 10 that is held in the roll housing 24. Thereby, it is possible to arrange the blanket roll 10 at the predetermined retraction height Ha or the contact height Hb that is detected by the height sensor 14, by moving the blanket roll 10 along the linear guide 26 in the vertical direction integrally with the roll housing 24 along with synchronized driving of each lift actuator 13. Accordingly, in the state of the blanket roll 10 that has been lifted to the retraction height Ha, it is possible to allow the plate table 4 and the substrate table 6 that move along the guide rails 2 to pass therebelow without interfering with the blanket roll 10.

Also, in the state of the plate table 4 and the substrate table 6 being arranged direction below the blanket roll 10, by lowering the blanket roll 10 integrally with the roll housing 24 by the lift actuators 13 until the contact height Hb, it is possible to press the peripheral wall surface of the blanket roll 10 from above against the plate 3 that is held on the upper surface portion of the plate table 4 and the substrate 5 that is held on the upper surface portion of the substrate table 6. At this time, it is possible to detect the contact pressure of the blanket roll 10 with respect to the plate 3 on the plate table 4 and the substrate 5 on the substrate table 6 as a reaction force to the force of the lift actuators 13 biasing the blanket roll 10 downward integrally with the roll housing 24, by each pressure sensor 15 that is provided in series with each lift actuator 13.

On one side of the roll housing 24, the drive motor 11 is attached so as to face inward. Then, by connecting an output shaft which is not illustrated of the drive motor 11 to the rotation shaft 23 on one side of the blanket roll 10 that is held in a freely rotatable manner by the bearing 25 on one side of the roll housing 24 in the longitudinal direction, it is possible to rotationally drive the blanket roll 10 by operation of the drive motor 11.

Furthermore, the encoder 12 is attached to the output shaft which is not illustrated of the drive motor 11. Then, it is possible with the encoder 12 to detect the rotation speed of the blanket roll 10 and the rotation angle (the angle having one position in the circumferential direction as a reference) of the blanket roll 10 when rotationally driving the blanket roll 10 by operation of the drive motor 11.

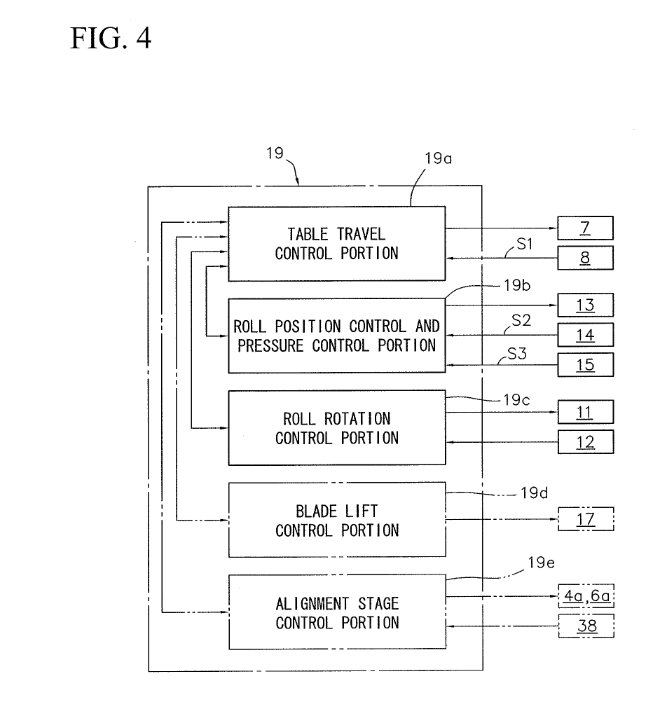

As shown in the control configuration in FIG. 4, the controller 19 is provided with a table travel control portion 19a and a roll position control and pressure control portion 19b, and a roll rotation control portion 19c. The table travel control portion 19a controls the positions, the movement direction (travel direction) and movement speed (travel velocity) of the tables 4 and 6 by issuing commands to the individual drive units 7 of the plate table 4 and the substrate table 6, based on individual table position detection signals Si of the plate table 4 and the substrate table 6 that are input from the linear scale 8 that is provided on the trestle 1. The roll position control and pressure control portion 19b controls the height of the blanket roll 10 and the contact pressure of the blanket roll 10 with respect to the plate 3 and the substrate 5 by giving commands to each lift actuator 13 of the blanket roll 10, based on a detection signal S2 of the height of the blanket roll 10 that is input from each height sensor 14 in the transfer mechanism portion 9, and a detection signal S3 of the contact pressure of the blanket roll 10 with respect to the plate 3 and the substrate 5 that is input from each pressure sensor 15. The roll rotation control portion 19c controls the rotation speed and the rotation angle of the blanket roll 10 by issuing commands to the drive motor 11 of the blanket roll 10, based on the detection signal of the rotation speed and the rotation angle of the blanket roll that is input from the encoder 12 that is attached to the drive motor 11 of the blanket roll 10. Furthermore, the roll position control and pressure control portion 19b and the roll rotation control portion 19c can perform control in synchronization with table travel control portion 19a.

Furthermore, the controller 19 is provided with a function that performs roll height control for arranging the blanket roll 10 at either of the retraction height Ha or the contact height Hb as necessary, and a function that performs contact pressure constant control that makes constant the contact pressure of the blanket roll 10 with respect to the plate 3 in the case of performing transfer (reception) by bringing the blanket roll 10 into contact with the plate 3, and that makes constant the contact pressure of the blanket roll 10 with respect to the substrate 5 in the case of retransfer (printing) by bringing the blanket roll 10 into contact with the substrate 5, as a control function thereof.

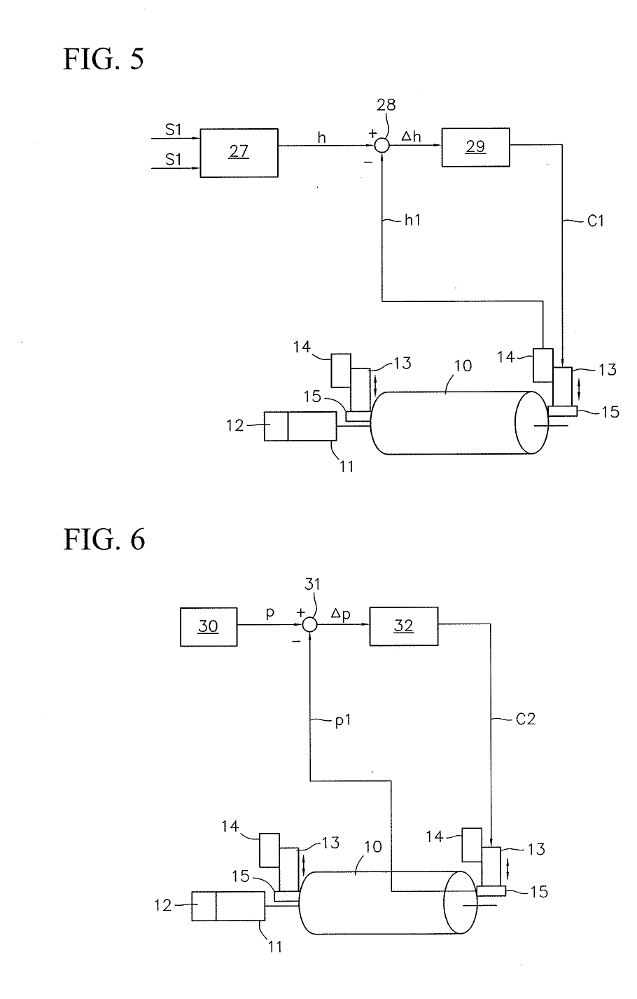

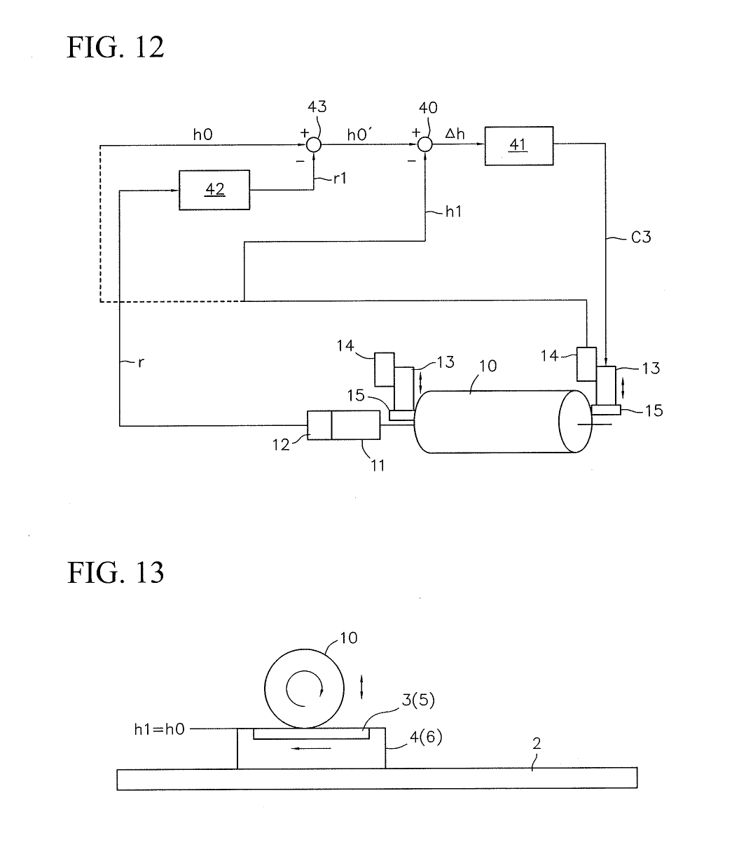

The specific roll height control by the controller 19 is described with the control block diagram shown in FIG. 5. Note that in FIG. 5, for the sake of convenience, descriptions of the frame 20 of the transfer mechanism portion 9 and the roll housing 24 of the blanket roll 10 are omitted, and the shape and arrangement of the drive motor 11, the encoder 12, the lift actuator 13, the linear scale 14 as the height sensor, and the pressure sensor 15 that are attached to the blanket roll 10 are changed. Also, the description of the control system of the lift actuator 13 on one side of the blanket roll 10 is omitted (in the same manner as FIG. 6 and FIG. 12).

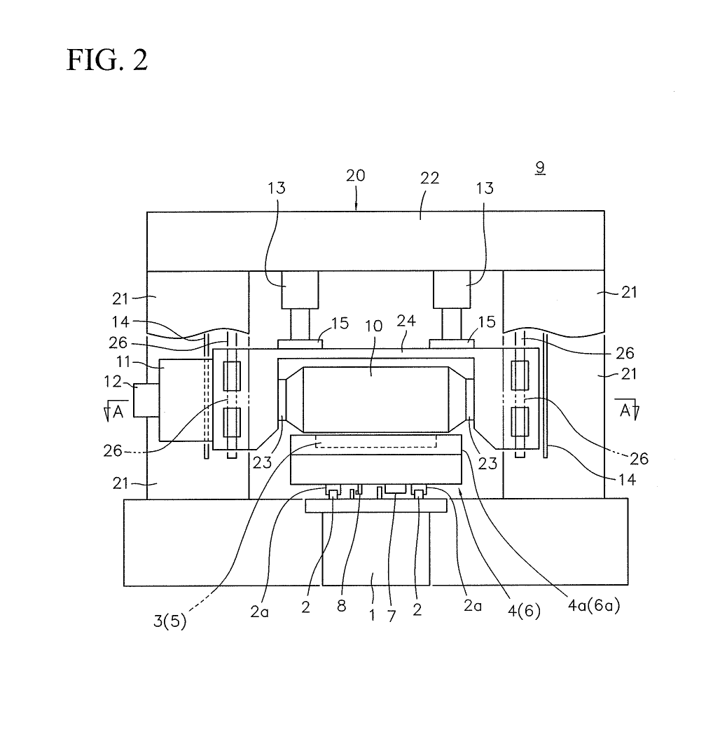

When the table position detection signal S 1 relating to the position in the X-axis direction of the plate table 4 and the position in the X-axis direction of the substrate table 6 by the linear scale 8 on the trestle 1 (refer to FIG. 2 and FIG. 4) is input, the controller 19 judges whether the blanket roll 10 should be arranged at the retraction height Ha or the contact height Hb by performing a table function process 27 by a required table function that is set in advance, based on each table position detection signal S1, and outputs a height target value h of the retraction height Ha or the contact height Hb. Next, by inputting to a subtractor 28 the height target value h and the height current value h1 of the blanket roll 10 based on the detection signal that is input by the height sensor 14 of the transfer mechanism portion 9, the controller 19 finds the height deviation Δh of the height current value h1 with respect to the height target value h, and thereafter the drive command C1 that is found by performing a feedback process 29 based on feedback control theory such as PID control for making this height deviation Δh zero is issued to the lift actuators 13 of the blanket roll 10.

In this way, by operating the lift actuators 13 based on the drive command C1, in accordance with the position of the plate table 4 or the substrate table 6 in the X-axial direction, it is possible to arrange the blanket roll 10 at the contact height Hb in the case of positioning it to be brought into the contact position in order to perform transfer of ink between the blanket roll 10 and the plate 3 or substrate 5 as described below, or otherwise arrange the blanket roll 10 at the retraction height Ha.

Also, with regard to contact pressure fixed control of the blanket roll 10 by the controller 19, a description is given with the control block diagram shown in FIG. 6.

That is, in the case of performing transfer (reception) of ink from the plate 3 to the blanket roll 10, it is necessary to stick the ink that has been inked on the plate 3 to the surface of the blanket roll 10. On the other hand, in the case of retransferring the ink from the blanket roll 10 to the substrate 5 that serves as the print target, it is necessary to stick the ink that is stuck to the surface of the blanket roll 10 to the surface of the substrate 5 by being detached from the surface of the blanket roll 10. For that reason, the transfer characteristics of the ink from the plate 3 to a blanket roll 10, and the transfer characteristics of the ink from the blanket roll 10 to the substrate 5 are not necessarily the same. Moreover, in order to improve the transfer performance in the entire offset printing, the contact pressure that is desired when bringing the blanket roll 10 into contact with the plate 3, and the contact pressure that is desired when bringing the blanket roll 10 into contact with the substrate 5 are not necessarily the same.

Then, in the case of performing contact pressure fixed control of the blanket roll 10, in accordance with the object of contact with the blanket roll 10 being the plate 3 or the substrate 5, the target value p of a certain contact pressure that is desired is individually set by the pressure determining block 30 in advance. Then, by inputting this pressure target value p, and the present value p1 of the contact pressure of the blanket roll 10 with respect to plate 3 that is held by the plate table 4 or the substrate 5 that is held by the substrate table 6 that is input by the pressure sensor 15 of the transfer mechanism portion 9 to a subtractor 31, the pressure deviation Δp of the contact pressure current value p1 with respect to the pressure target value p is found. Furthermore, a drive command C2 that is found by performing a feedback process 32 based on a feedback control theory such as PID control or the like in order to make this pressure deviation Δp zero is given to the lift actuator 13 of the blanket roll 10. By operating the lift actuator 13 based on the drive command C2, when performing transfer of ink between the blanket roll 10 and the plate 3 or the substrate 5 as described below, it is possible to bring the blanket roll 10 into contact with the plate 3 or the substrate 5 with a fixed contact pressure in accordance with a pressure target value p that is respectively desired.

At this time, in the state of both end portions in the axial center direction of the blanket roll 10 being biased downward by the two lift actuators 13 that are provided nearly corresponding to both end portions in the axial center direction of the blanket roll 10, by monitoring the contact pressure current value p1 with the pressure sensor 15 that is provided at each lift actuator 13, and individually performing control of the two lift actuators 13 by the same procedure as described above, it is possible to equalize the contact face pressure of the blanket roll 10 with respect to the plate 3 and the substrate 5.

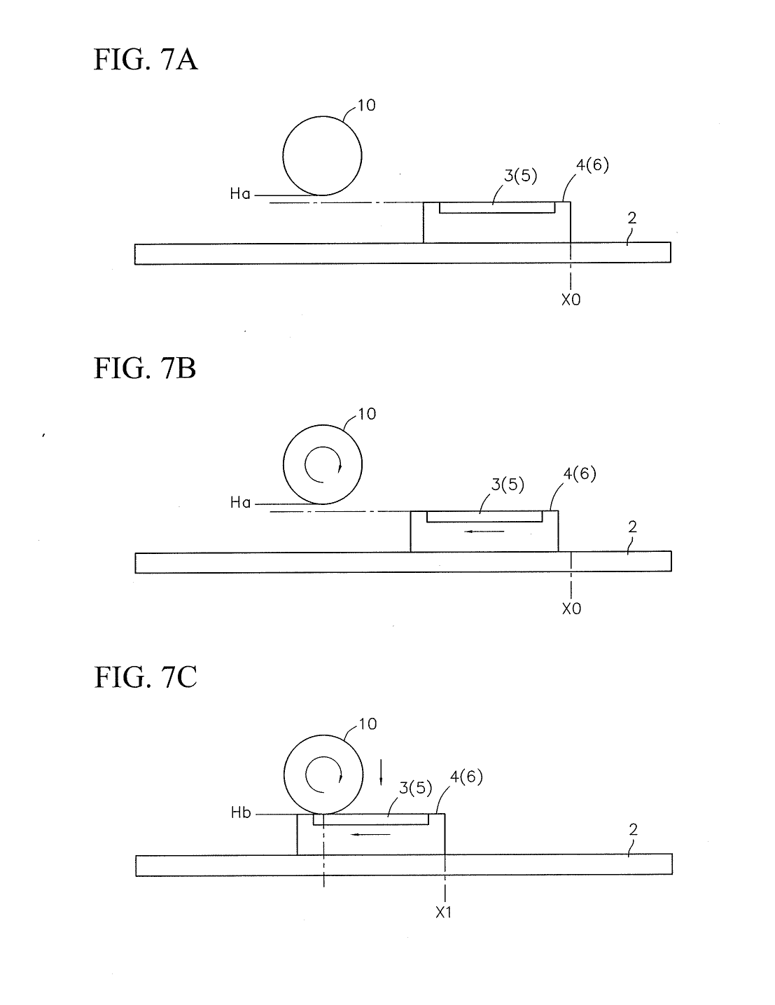

When carrying out offset printing by the offset printing apparatus of the present invention with the controller 19 that is provided with a height control function and a contact pressure constant control function of the blanket roll 10 as described above, the transfer operation in the case of performing transfer (reception) of ink from the plate 3 to the blanket roll 10 in the transfer mechanism portion 9 is performed by the procedure shown in FIG. 7A to FIG. 9B.

Note that in the aforementioned drawing, the rotation direction of the blanket roll 10 during transfer is the clockwise direction, and the travel direction for transfer of the plate table 4 is made to head from other end side toward the one end side in the longitudinal direction of the guide rails 2 (leftward).

When performing the transfer operation from a plate 3 to the blanket roll 10, as shown in FIG. 7A, the blanket roll 10 is beforehand arranged at the retraction height Ha using the height control function of the blanket roll 10 shown in FIG. 5. In addition, rotation of the blanket roll 10 is stopped at this point. Moreover, in the state of inking being performed in advance by the inking apparatus 17 on the plate 3 that is held on the plate table 4, the plate table 4 is arranged at the transfer start position X0 that is set beforehand more on the upstream side in the travel direction for transfer than directly under the blanket roll 10, and once stopped. Note that in the drawing, the table position is defined with the end portion of the plate table 4 approaching the other end of the guide rails 2 in the longitudinal direction (the left end portion in the drawing) serving as the reference.

Next, as shown in FIG. 7B, the blanket roll 10 is made to rotate by operation of the drive motor 11, in the state of being arranged at the retraction height Ha. Also, the plate table 4 that has been stopped at the transfer start position Xa is made to travel in the transfer travel direction by operation of the drive apparatus (refer to FIG. 2) 7. At this time, the rotation speed of the blanket roll 10 and the travel speed of the plate table 4 are set so that the circumferential speed based on the roll diameter of the deformed portion of the blanket roll 10 when a deformation arises in the contact portion of the blanket roll 10 with the plate 3 by contacting the blanket roll 10 to the plate 3 so as to press against the plate 3 with a predetermined pressure that is set in advance by performing control that makes constant the contact pressure as described below, and the travel velocity of the plate table 4 agree. Furthermore, based on the roll diameter of the portion that deforms along with contacting the blanket roll 10 with the plate 3, phase synchronization control is performed so that the circumferential direction position of the blanket roll 10 that has the contact position between the blanket roll 10 and the plate 3 as the start point when starting transfer in the next step by contacting the blanket roll 10 with the plate 3 that is held on the plate table 4, and the X-axis direction position of the plate table 4 agree.

Next, as shown in FIG. 7C, at the point in time at which the plate table 4 that is traveling in the transfer travel direction has reached the roller contact position X1 at which it has proceeded by a required amount directly under the blanket roll 10, the controller 19, using the height control function of the blanket roll 10 shown in FIG. 5, issues a drive command C1 for height control to each lift actuator 13 to lower the blanket roll 10 until the contact height Hb that is set in advance, and brings the lower end portion on the outer periphery of the blanket roll 10 into contact with the plate 3 that is held on the plate table 4. Note that in the case of performing inking of the plate 3 that is held on the plate table 4 as described below by the inking apparatus 17, since an ink pool is formed at the end area of the plate 3 approaching the one end of the guide rails 2 in the longitudinal direction, the contact position of the blanket roll 10 with respect to the plate 3 is set so that the blanket roll 10 does not come into contact with this ink pool.

As described above, when the peripheral wall surface of the blanket roll 10 is brought into contact with the plate 3 on the plate table 4, the pressure current value p1 of the contact pressure of the blanket roll 10 with respect to the plate 3 is detected by each pressure sensor 15 that is provided win series with each lift actuator 13 of the blanket roll 10 in the transfer mechanism portion 9.

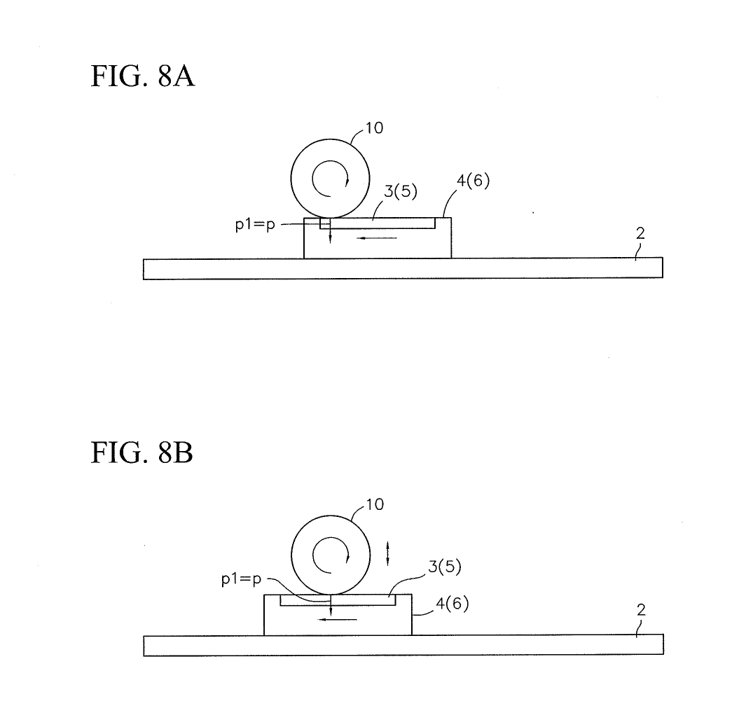

The detection signal of the pressure current value p1 of the contact pressure, detected by each aforementioned pressure sensor 15, of the blanket roll 10 with respect to the plate 3 that is arranged at the contact height Hb is input to the controller 19. In the controller 19, the function thereof is switched from height control of the blanket roll 10 shown in FIG. 5 to the contact pressure constant control shown in FIG. 6, and the drive command C2 for pressure control is issued to each lift actuator 13 of the blanket roll 10. As a result, the pressure current value p1 of the contact pressure of the blanket roll 10 with respect to the plate 3 that is detected by the pressure sensor 15 is held so as to be constant at the pressure target value p of the predetermined contact pressure that is set in advance, as shown in FIG. 8A. Note that at this time, the rotational speed of the blanket roll 10 and the moving speed of the plate 3 due to travel of the plate table 4 may be decelerated while maintaining mutual synchronization, until the contact pressure of the blanket roll 10 with respect to the plate 3 becomes a stable value.

Thereafter, as shown in FIG. 8B, while the rotating blanket roll 10 performs transfer by making contact with the plate 3 of the traveling plate table 4, the controller 19 controls each lift actuator 13 of the blanket roll 10 so that the pressure current value p1 of the contact pressure of the blanket roll 10 with respect to the plate 3 that is detected by each pressure sensor 15 is held constant at the target value p of the predetermined contact pressure (refer to FIG. 6). Thereby, the amount of deformation that occurs in the blanket roll 10 at the contact portion with the plate 3 is held at a certain constant amount.

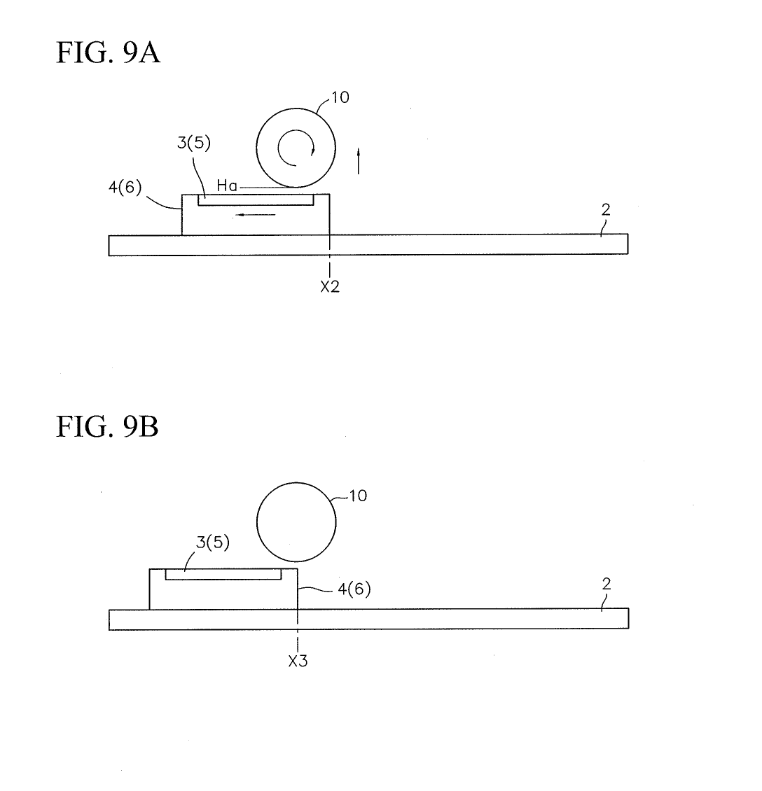

After the transfer from the blanket roll 10 to the plate 3 is complete, as shown in FIG. 9A, when the plate table 4 reaches the roller separation position X2 that has been set prior to completely passing directly under the blanket roll 10, in the state of continuing the rotation of the blanket roll 10 and the travel of the plate table 4, the controller 19 issues a drive command C1 for height control to each lift actuator 13 by the height control function of the blanket roll shown in FIG. 5 to lift the blanket roll 10 until the retraction height Ha. Note that after the blanket roll 10 has been lifted and separated from the plate 3 as described above, the synchronization control of the rotation speed of the blanket roll 10 and the travel velocity of the plate table 4 may be released.

Then, as shown in FIG. 9B, when the plate table 4 travels to the transfer complete position X3, the controller 19 stops the rotation of the blanket roll 10 that has been lifted to the retraction height Ha, to restore it to the initial state similarly to that shown in FIG. 7A.

In the case of performing retransfer (printing) of ink from the blanket roll 10 to the substrate 5 that is the print target, after having performed transfer (reception) of the ink from the plate 3 to the blanket roll 10 by the procedure shown in the aforementioned FIG. 7A to FIG. 9B in the transfer mechanism portion 9, the substrate table 6 that holds the substrate 5 serving as a print target is used instead of the plate table 4 that holds the plate 3. And, by performing the transfer operation by means of the same procedure as shown in FIG. 7A to FIG. 9B with the controller 19, it is possible to perform retransfer (printing) of the ink from the blanket roll 10 to the substrate 5.

Note that when contacting the blanket roll 10 with the substrate 5 with a constant contact force, in the same manner as the case shown in FIGS. 8A and B, by the contact pressure constant control function shown in FIG. 6 of the controller 19, as described above, the pressure target value p of the contact pressure when the blanket roll 10 is brought into contact with the substrate 5 is separately set from the pressure target value p of the contact pressure when the blanket roll 10 is brought into contact with the plate 3. For that reason, the deformation amount of the contact portion of the blanket roll 10 when the blanket roll 10 is brought into contact with the substrate 5 with a fixed contact pressure does not necessarily agree with the deformation amount of the contact portion when the blanket roll 10 is brought into contact with the plate 3.

Therefore, in the case of performing the retransfer (printing) of ink from the blanket roll 10 to the substrate 5, the difference in the deformation amounts of the blanket roll 10 that occurs due to the difference in the contact press with respect to the plate 3 and the substrate 5 is measured in advance. Then, in consideration of the change in the circumferential speed due to the difference in that deformation amount, between FIG. 7B and FIG. 9A, the rotation speed of the blanket roll 10 and the travel velocity of the substrate table 6 are corrected and set so that the circumferential speed based on the roll diameter of the deformation portion that occurs at the contact portion between the blanket roll 10 and the substrate 5 when the blanket roll 10 is brought into contact with the substrate 5 at a predetermined contact pressure that is set in advance by performing contact pressure constant control, and the travel speed of the substrate table 6 agree. Thereby, when the blanket roll 10 makes contact with the substrate 5 that is held on the substrate table 6, contact pressure constant control is performed in the same manner as shown in FIGS. 8A and B. Accordingly, even if the thickness dimension changes for each substrate 5 that is the print target, the pressure when the blanket roll 10 makes contact with each substrate 5 is made uniform. Therefore, the deformation amount of the contact portion when the blanket roll 10 makes contact with each substrate 5 is the same every time. For that reason, it is possible to increase the reproducibility of the print pattern that is retransferred from the blanket roll 10 to each substrate 5, and as a result, even if the print pattern that is to be printed to each substrate 5 is one that has fine lines in the manner of a fine electrode pattern, it is possible to print the fine lines by a uniform thickness with high reproducibility.

In the case of the axial center of the blanket roll 10 not necessarily completely agreeing with the axial center of the rotating shafts 23 at both ends due to the fabrication accuracy of the blanket roll 10, the circumferential position may become uneven due to an angle of rotation stemming from the aforementioned eccentricity in the blanket roll 10. Since the controller 19 controls the contact pressure of the blanket roll 10 with the plate 3 or the substrate 5 in a constant manner, even if the blanket roll 10 is eccentric as above, it is possible to make the deformation amount of the contact portion of the blanket roll 10 with the plate 3 or the substrate 5 uniform. However, even if the above-mentioned contact pressure constant control is performed, it is not possible to prevent a change occurring in the circumferential speed due to the angle of rotation of the blanket roll 10 caused by the eccentricity. On the other hand, the circumferential speed of the blanket roll 10 is obtained by multiplying the distance from the axial center of the angle of rotation to the plate 3 or the substrate 5, that is, the radius of rotation by the angle of rotation. For that reason, in the case of eccentricity arising in the blanket roll 10, in the state of holding a substrate for inspection that is not illustrated with a known thickness on the substrate table 6, by bringing the blanket roll 10 into contact with the aforementioned inspection substrate by rotating the blanket roll 10 while performing contact pressure constant control with the contact pressure during transfer from the plate 3 and the contact pressure during retransfer to the substrate 5, changes in the height of the blanket roll 10 that are detected by the linear scale 14 as a height sensor at that time are recorded together with rotation angle changes of the blanket roll 10. Then, by finding the difference between the height of the blanket roll 10 that is recorded and the known height of the aforementioned inspection substrate, it is possible to respectively obtain the rotation radius of the contact portion from the contact pressure during transfer from the plate 3 and the contact pressure during retransfer to the substrate 5 when the blanket roll 10 assumes a certain rotation angle.

Accordingly, for the blanket roll 10 that is eccentric, by creating a correction table that records the rotation radius for the rotation angle of the blanket roll 10, and issuing a command to the drive motor 11 of the blanket roll 10 based on it, to add a correction that suitably changes the rotation speed of the drive motor 11 in accordance with the rotation angle of the blanket roll 10, it is possible to make constant the circumferential speed of the blanket roll 10.

Alternatively, by adding a correction to the travel velocity of the plate table 4 or the substrate table 6 in accordance with the change in the circumferential speed of the eccentric blanket roll 10, the circumferential speed of the blanket roll 10 and the moving speed of the plate 3 on the plate table 4 or the substrate 5 on the on the substrate table 6 may be synchronized.

Note that by periodically measuring and updating the rotation radius data of the eccentric blanket roll 10, it may be made to correspond to changes over time such as wear and the like of the blanket roll 10.

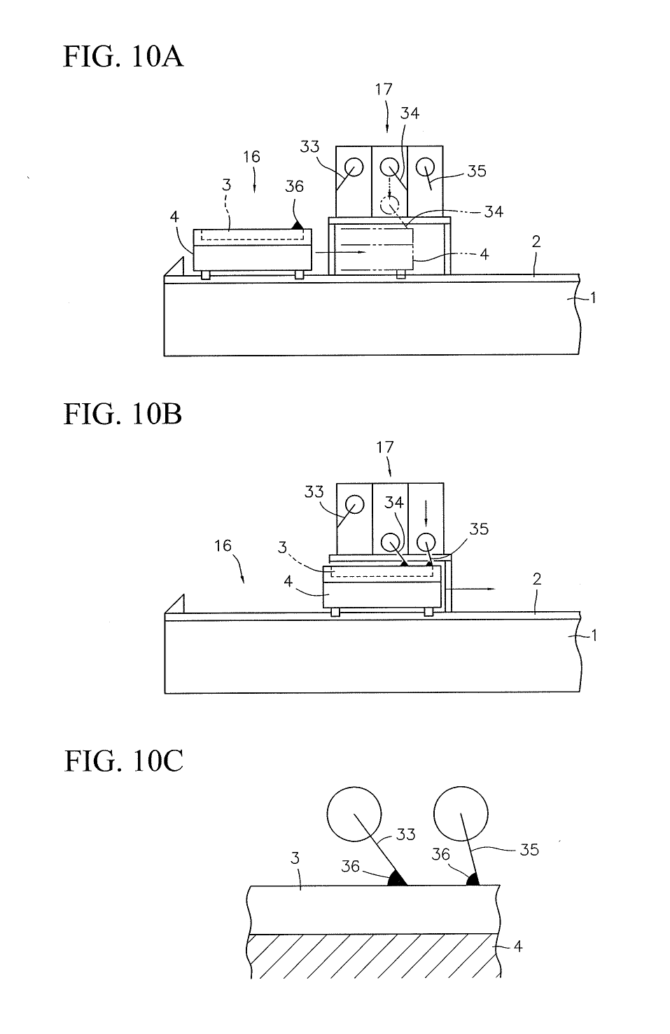

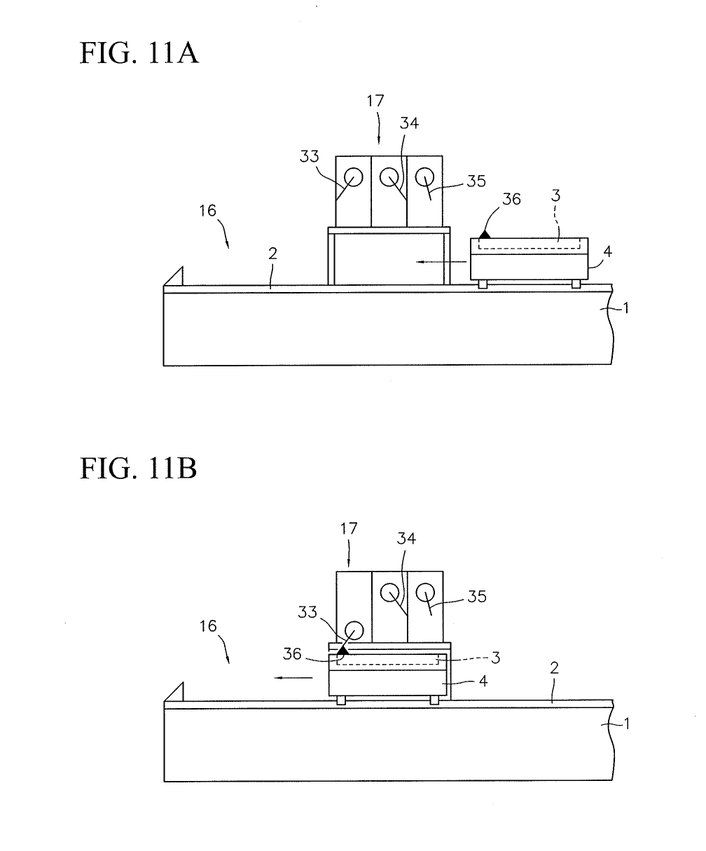

As shown in FIG. 1, FIGS. 10A to C, and FIGS. 11A and B, the inking apparatus 17 is provided with an ink-returning blade 33, an ink-pushing blade 34, and an ink-scraping blade 35 in turn from the one end side of the guide rails 2 in the longitudinal direction at an evacuation height that is somewhat above the upper surface of the plate table 4 along the guide rails 2. Also, an actuator, not illustrated, is provided so as to be able to individually lower the blades 33, 34, and 35 to a position at which the lower end portions thereof contact the plate 3 that is held on the plate table 4.

The ink-returning blade 33 is inclined so that its lower end side is positioned nearer the one end portion of the guide rails 2 in the longitudinal direction than its upper end side.

Also, the ink-pushing plate 34 and the ink-scraping blade 35 are inclined so that their upper end sides are positioned nearer the other end of the guide rails in the longitudinal direction than their lower end sides. Moreover, the angle of incline from a horizontal plane of the ink-pushing blade 34 is smaller than that of the ink-scraping blade 35. Thereby, even in the case of using ink with high viscosity such as conductive paste as the ink, it is possible to increase the fillability of the ink to the plate 3 by using the ink-pushing blade 34 having an angle of incline from the horizontal plane that is comparatively small. Also, as a result of once being forcibly pushed into the plate 3 by the ink-pushing blade 34, the excess portion of ink that swells from the plate 3 after the ink-pushing blade 34 has passed is scraped off by the ink-scraping blade 35 that has improved scraping performance by having an increased angle of incline from the horizontal plane, and so it is possible to perform inking of an appropriate amount of ink on the plate 3. When performing inking to a plate by the inking apparatus 17, as shown in FIG. 10A, the plate 3 is attached to the upper surface portion of the plate table 4 that is arranged in the plate table standby area 16 of the trestle 1, and the ink pool 36 of a required amount, for example, ink such as conductive paste serving as the ink pool 36, is placed at the end portion on the other end side of the guide rails 2 on the surface of the plate 3. In this state, as shown by the two-dot chain line in FIG. 10A, the plate table 4 is made to move along the guide rails 2 to the other end side of the guide rails 2 in the longitudinal direction, and made to move through the inking apparatus 17 to the transfer mechanism portion 9 side. At this time, first, the ink-pushing blade 34 is lowered to a position that makes contact with the plate 3, just before the end portion of the plate 3 at the other end side of the guide rails 2 reaches just below, and next, as shown in FIG. 10B, the ink-scraping blade 35 is lowered to a position that makes contact with the plate 3 just before the end portion of the plate 3 at the other end side of the guide rails 2 reaches just below. As a result, as shown in FIG. 10C, the ink of the ink pool 36 that is placed on the surface of the plate 3 at the end portion on the other end side of the guide rails 2 is pressed into the plate 3 by the ink-pushing blade 34 that slides relatively on the surface of the plate 3 with the movement of the plate table 4 to the other end side of the guide rails 2 in the longitudinal direction. Next, by scraping off the excess portion of the ink that has been pressed into the plate 3 with the ink-scraping blade 35 that slides relatively on the surface of the plate 3 in the same manner as the ink-pushing blade 34, inking is performed on the plate 3. The plate 3 that has been inked is sent to the transfer mechanism portion 9 side by movement of the plate table 4.

Note that the ink-pushing blade 34 and the ink-scraping blade 35 separate from the plate 3 and are lifted to the retraction position just before the end portion of the plate 3 of the one end side of the guide rails 2 passes directly below. As a result, it is possible to collect the ink pool 36 of the ink-pushing blade 34 and the ink-scraping blade 35, which slide with respect to the plate 3, that is formed on the one end side of the guide rails 2 in the longitudinal direction on the surface of the plate 3 at the end portion on the one end side of the guide rails 2 after passing the inking apparatus 17. Furthermore, by sending the plate table 4 that holds the plate 3 in the state of having the ink pool 36 in this state to the transfer mechanism portion 9, it is possible to perform transfer of ink from the plate 3 to the blanket roll 10.

Thereafter, the plate table 4 that holds the plate 3, after being supplied to the transfer of ink to the blanket roll 10, is moved from the transfer mechanism portion 9 side to the one end side of the guide rails 2 in the longitudinal direction and returned to the plate table standby area 16 through the inking apparatus 17. At this time, as shown in FIG. 11B, the ink-returning blade 33 that has been arranged at the aforementioned retraction position, is lowered to a position that makes contact with the surface of the plate 3 moving to the one end side of the guide rails 2 in the longitudinal direction accompanying movement of the plate table 4, and thereby is made to slide relatively on the surface of the plate 3 from the end portion on the one end side of the guide rails 2 to the end portion on the other side of the guide rails 2. As a result, the ink pool 36 that had been collected on the surface of the plate 3 by the ink-pushing blade 34 and the ink-scraping blade 35 at the end portion on the one end side of the guide rails 2 is returned to the end portion on the surface of the plate 3 at the other end side of the guide rails 2, whereby it is possible to put it in the initial state in the same manner as shown in FIG. 10A.

Furthermore, in the offset printing apparatus that is shown in FIG. 1, the plate table 4 and the substrate table 6 are respectively equipped on the upper portion with alignment stages 4a and 6a that are capable of horizontal movement in the longitudinal direction (X-axis direction) of the guide rails 2 and in a direction that is perpendicular to the longitudinal direction of the guide rails 2 (Y-axis direction), and rotation in a yaw angle (0) with respect to the longitudinal direction of the guide rails 2. Then, it is possible to attach the plate 3 and the substrate 5 that serves as the print target on the upper surface portion of the alignment stages 4a and 6a, respectively.

Furthermore, an alignment area 37 is provided at a required position that does not interfere with the transfer mechanism portion 9, the plate table standby area 16, the inking apparatus 17 and the substrate installation area 18 in the longitudinal direction of the trestle 1, for example, at a position between the mechanism portion 9 and the substrate installation area 18. Then, with the alignment area 37, it is possible to perform sensor feedback alignment correction of the relative position with respect to the tables 4 and 6 that respectively correspond, using the shared alignment sensor 38, for the plate 3 that is held on the alignment stage 4a of the plate table 4, and the substrate 5 that is held on the alignment stage 6a of the substrate table 6.

Specifically, in the alignment area 37 a supporting frame 39 is provided so that the plate table 4 and the substrate table 6 can pass below. Moreover, precision cameras 38 are provided as the alignment sensor 38 so as to face downward at each of two positions corresponding to a diagonal or four positions corresponding to the four corner portions of the plate table 4 and the substrate table 6 in the supporting frame 39.

When taking the initial alignment for the plate 3 that is held on the plate table 4, alignment markers, not illustrated, are pointed in advance at the diagonal or the four corner portions of the plate 3 that is used. Next, the plate table 4 to which the plate 3 is attached in the plate table standby area 16 is moved to the alignment area 37, and made to stop at a predetermined alignment position that is set in advance in the alignment area 37. Then, in this state, the alignment makers not illustrated of the diagonal or four corner portions of the plate 3 are detected by each precision camera 38 on the support frame 39, and by performing position correction by horizontal movement in the X-Y directions or rotation of the alignment stage 4a of the plate table 4 so that the alignment markers assume the predetermined arrangement, it is possible to make the relative position of the plate 3 with respect to the plate table 4 always have the same arrangement.

Also, in the case of taking the initial alignment for the substrate 5 that is held on the substrate table 6, alignment markers, not illustrated, are pointed in advance at the diagonal or the four corner portions of the substrate 5 that is used. Next, the substrate table 6 to which the substrate 5 serving as the print target is newly attached in the substrate installation area 18 is moved to the alignment area 37, and made to stop at the aforementioned predetermined alignment position. Then, in this state, the alignment makers not illustrated of the diagonal or four corner portions of the substrate 5 are detected by each precision camera 38 on the support frame 39, and by performing position correction by horizontal movement in the X-Y directions or rotation of the alignment stage 6a of the substrate table 6 so that the alignment markers assume the predetermined arrangement, it is possible to make the relative position of the substrate 5 with respect to the substrate table 6 always have the same arrangement.

Thereby, it is possible to make the relative arrangement of the substrate 5 on the substrate table 6 for which initial alignment has been taken in the alignment area 37 always have the same arrangement with respect to the position of the plate 3 on the plate table 4 when in the state in which initial alignment has been taken in the alignment area 37.

Note that in the case of performing overprinting on the substrate 5 serving as the print target that is held on the plate table 6, when strict reproducibility is not particularly required for the arrangement of the printing pattern of the first layer with respect to each substrate 5 serving as a print target, and the prevention of misalignment of the print pattern is more important, the alignment markers may be pointed by printing when performing the first printing on the substrate 5, instead of pointing the alignment markers in advance at the diagonal or four corners of the substrate 5. Thereby, in this case there is no need to perform alignment on the substrate 5 prior to performing the first printing on the substrate 5 that is held on the substrate table 6.

Note that as shown by the chain double-dashed line in FIG. 4, a blade lift control portion 19d may be provided in the controller 19 so as to perform lift control of the blades 33, 34, and 35 (refer to FIG. 1, FIGS. 10A to C, and FIGS. 11A and B) by an actuator, not illustrated, in the inking apparatus 17, and an alignment stage control portion 19e may be provided in the controller 19 to perform detection of alignment markers, not illustrated, of the plate 3 or the substrate 5 by the precision cameras 38 in the alignment area 37 (refer to FIG. 1), and position correction of the plate 3 by control of the alignment stage 4a of the plate table 4 based on the alignment makers that have been detected, and position correction of the substrate 5 by control of the alignment stage 6a of the substrate table 6. In this case, the blade control portion 19d and the alignment stage control portion 19e may perform synchronized control with the table travel control portion 19a.

Furthermore, instead of adding a correction to the rotation speed of the drive motor 11 of the blanket roll 10, or adding a correction to the travel velocity of the plate table 4 or the substrate table 6 as described above in the case of there being eccentricity in the blanket roll 10, by providing the alignment stages 4a and 6a in the plate stage 4 and the substrate table 6, respectively, the rotation angle of the blanket roll 10 and the travel position of the plate table 4 or the substrate table 6 are synchronized, and the misalignment in the position in the circumferential direction of the blanket roll 10, and the travel position of the plate table 4 or the substrate table 6 derived from the eccentricity may be corrected by an operation in the X direction of the alignment stage 4a of the plate table 4 or the alignment stage 6a of the substrate table 6.

According to the offset printing apparatus of the present invention that has the aforementioned constitution, it is possible to make constant the contact pressure when performing transfer of ink by bringing the blanket roll 10 into contact with the plate 3 in the transfer mechanism portion 9. For that reason, in the case of using a different plate 3 in order to perform overprinting, or in the case of having replaced the plate 3, it is possible to make the deformation amount constant when the blanket roll 10 comes into contact with the plate 3, and as a result, it is possible to make uniform every time the ink attachment condition when ink is transferred from the plate 3 to the blanket roll 10.

Also, it is possible to control the pressure to be uniform with respect to each substrate 5 when performing retransfer by bringing the blanket roll 10 into contact with the substrate that becomes the print target. For that reason, it is possible make the deformation amount of the contact portion when the blanket roll 10 is brought into contact with each substrate 5 the same each time, and as a result, the ink attachment condition when retransferring the ink from the blanket roll 10 to the substrate 5 can be made uniform every time.

Therefore, even in the case of the printing pattern forming an electrode with thin lines in the manner of a fine electrode pattern, it is possible to prevent a change in the thickness of the electrode to be printed as a fine line for each substrate 5 beforehand, and as a result it is possible to print an electrode with a uniform thickness on each substrate 5.

Furthermore, even if there are variations in the thickness dimension of the substrate 5 that is the print target, it is possible make uniform the deformation amount of the contact portion of the blanket roll 10 that makes contact with each substrate 5. For that reason, it is possible to prevent variations in the circumferential speed of the blanket roll 10 beforehand when retransferring ink from the blanket roll 10 to each substrate 5, and it is possible to synchronize the circumferential speed of the blanket roll 10 and the moving speed of the substrate 5 that is held on the substrate stage 6. As a result, it is possible to prevent variations in the print accuracy and reproducibility that arise in each substrate 5 beforehand.

In the same manner, even if there are variations in the thickness dimension of each plate 3 for performing overprinting, and variations in the thickness dimension between the plate 3 prior to replacement and the plate 3 after replacement in the case of replacing the plate 3, it is possible to make uniform the deformation amount of the contact portion of the blanket roll 10 that makes contact with each plate 3. For that reason, it is possible to prevent variations in the circumferential speed of the blanket roll 10 beforehand when transferring ink from these plates 3 to the blanket roll 10, and it is possible to synchronize the circumferential speed of the blanket roll 10 and the movement speed of the plate 3 that is held on the plate table 4. As a result, it is possible to print with accuracy and high reproducibility a fine print pattern such as an electrode pattern on the substrate 5, and even when overprinting a fine print pattern such an electrode pattern on the substrate 5, it is possible to inhibit misalignment, and it is possible to achieve a constitution that is advantageous for suppressing misalignment to a micrometer-order.

In addition, since it is possible to take alignment so that the relative position of the plate 3, which is held on the plate table 4, with respect to the plate table 4, and the relative position of the substrate 5, which is held on the substrate table 6, with respect to the substrate table 6 agree in the common alignment area 37, it is possible to move the plate 3 and the substrate 5 that are held on the plate table 4 and the substrate table 6 that travel along the same guide rails 2 respectively, with the same angle arrangement and the same trajectory along the guide rails 2. For that reason, it is possible to further increase the reproducibility when printing on the substrate 5 a print pattern that is formed on the plate 3.

Next, FIG. 12 and FIG. 13 show other embodiments of the present invention. In these embodiments, under the same constitution as shown in FIG. 1 to FIG. 11B, in addition to the roll height control function of the blanket roll 10 as shown in the control block drawing in FIG. 5 and the contact pressure constant control function of the blanket roll 10 shown in the control block drawing of FIG. 6, it is provided that a roll height retention control function for retaining the height of the blanket roll 10 with respect to the plate 3 or the substrate 5 after the contact pressure constant control is completed based on the contact pressure constant control function, as shown in the control block drawing of FIG. 12.

Specifically, in the roll height retention by the controller 19, a predetermined contact pressure height Hc that is the height of the blanket roll 10 that is detected by the height sensor 14 of the transfer mechanism portion 9 at the point in time of completion of the contact pressure constant control of the blanket roll 10 with respect to the plate 3 or substrate 5 based on the function of the contact pressure constant control shown in the aforementioned FIG. 6 is made to be roll height retention target value h0. Then, the roll height retention target value h0 and the height current value h1 of the blanket roll 10 based on a detection signal that is input by the height sensor 14 after completion of the aforementioned contact pressure constant control are input to the subtractor 40 to find the height deviation Δh of the height current value h1 with respect to the roll height retention target value h0. Then, a drive command C3 that is found by performing a feedback process 41 based on feedback control theory such as PID control for making this height deviation Δh to zero is issued to the lift actuator 13 of the blanket roll 10. Thereby, after once bringing the blanket roll 10 into contact with the plate 3 or the substrate 5 with a predetermined contact pressure by performing the aforementioned contact pressure constant control, it is possible to retain the height of the blanket roll 10 in a constant manner. As a result, the deformation amount of the contact portion at the point in time of the blanket roll 10 being brought into contact with the plate 3 or the substrate 5 with a predetermined contact pressure is maintained constant, and it is possible to prevent changes in the circumferential speed due to the roll diameter beforehand.

Moreover, the controller 19 in the present embodiment has the following constitution, as shown in FIG. 12, in order to be able to maintain constant the deformation amount of the contact portion when the blanket roll 10 is brought into contact with the plate 3 or the substrate 5 by a predetermined contact force at the point in time of completion of the contact pressure constant control, even if an eccentricity exists in the blanket roll 10 due to the manufacturing accuracy. That is, by performing a table function process 42 based on a correction table that is found by measuring in advance the non-uniformity of the rotation angle and circumferential position of the blanket roll 10, based on a detection signal r of the encoder 12 that is attached to the drive motor 11 of the blanket roll 10, an eccentricity correction value r1 of the circumferential position corresponding to the rotation angle of the blanket roll 10 is found. Also, after adding a correction in advance with the eccentricity correction value r1 to the roll height retention target value h0 at the point in time of completion of the aforementioned contact pressure constant control, the height deviation Δh of the height current value h1 with respect to the roll height retention target value h0′ after this correction is found. After that, a drive command C3 is found by performing a feedback process 41 for making this height deviation Δh to zero.

The transfer operation procedure in the case of using the controller 19 that has the roll height retention control function shown in FIG. 12 is as follows. First, using the roll height control function of the controller 19 shown in FIG. 5, the same operations as shown in FIGS. 7A to C is performed on the blanket roll 10 and the plate table 4 to lower the blanket roll 10 until the contact height Hb from the retraction height Ha, and bring the peripheral wall surface of the blanket roll 10 into contact with the plate 3 on the plate table 4. Then, by the contact pressure constant control function shown in FIG. 6, the pressure current value p1 of the contact pressure of the blanket roll 10 with respect to the plate 3 that is detected by the pressure sensor 15 is made to agree with the pressure target value p of the predetermined contact pressure that is set in advance in the same manner as shown in FIG. 8. Thereafter, the function of the controller 19 is switched to the roll height control function shown in FIG. 12 that makes the height of the blanket roll 10 that is detected by the height sensor 14 the roll height retention target value h0 at the point in time in which the aforementioned pressure constant control is performed, as shown in FIG. 13. Then, while performing transfer by the rotating blanket roll 10 making contact with the plate 3 on the traveling plate table 4, the lift actuator 13 (refer to FIG. 12) of each blanket roll 10 is controlled so that the height of the blanket roll 10 that is detected by the height sensor 14 is held at the roll height retention target value h0. Thereby, in the blanket roll 10, the deformation amount that occurs at the contact portion with the plate 3 is held at a constant amount.

After the transfer of ink from the blanket roll 10 to the plate 3 is finished, the transfer operation may be completed in the same manner as shown in FIGS. 9A and B.

Also, the retransfer of ink from the blanket roll 10 to the substrate 5 is also possible by performing a transfer operation in the same manner as above on the substrate table 6 that holds the substrate 5 instead of the plate table 4 that holds the plate 3.

Accordingly, by the present embodiment, it is possible to make uniform the contact pressure when the blanket roll 10 is brought into contact with the plate 3, in the same manner as the aforementioned embodiment. As a result, in the case of using a different plate 3 in order to perform overprinting, or in the case of having replaced the plate 3, it is possible to make uniform the deformation amount when the blanket roll 10 makes contact with the plate 3. Also, since it is possible to make uniform the contact pressure when bringing the blanket roll 10 into contact with the substrate 5, it is possible to make the deformation amount of the contact portion when the bringing the blanket roll 10 into contact with each substrate 5 the same each time.

Therefore, even in the case of the printing pattern forming an electrode with thin lines in the manner of a fine electrode pattern, it is possible to prevent a change in the thickness of the electrode to be printed as a fine line for each substrate 5 beforehand. As a result it is possible to print an electrode with a uniform thickness on each substrate 5, and it is possible to print a fine print pattern such as an electrode pattern on each substrate 5 with accuracy and high reproducibility. Therefore, in the present embodiment, it is possible to obtain the same effect as the aforementioned embodiment.

Note that the present invention is not limited to only the aforementioned embodiment. For example, the arrangement and shape of the lift actuator 13 and height sensor 14 of the blanket roll 10 may be appropriately changed, such as having the lift actuator 13 of the blanket roll 10 be a ball screw mechanism, and having the height sensor 14 of the blanket roll 10 be an encoder that is provided on a drive motor (servo motor) of the aforementioned ball screw mechanism (servo motor). Also, if it is possible to detect the pressure when pressing the blanket roll 10 against the plate 3 or the substrate 5 that serves as the print target with the lift actuator 13, the arrangement and shape of the pressure sensor 15 may be appropriately changed.

In the aforementioned embodiment, force for bringing the blanket roll 10 into contact with the plate 3 or the substrate 5 is applied to the rotation axis portions of the blanket roll 10 with the two lift actuators 13 that are provided at positions corresponding to both end portions in the axial center direction of the blanket roll 10. However, the position of applying downward force to the blanket roll 10 may be arbitrarily changed provided it is a portion in the blanket roll 10 where the blanket (not illustrated) is not attached. For example, constitution may be adopted that pushes downward both end portions in the axial center direction of the cylindrical shape, and a constitution may be adopted that applies pressure downward on an arbitrary portion of the cylindrical surface in which the blanket is not attached, with the attachment surface area of the blanket (not illustrated) in the blanket roll 10 being one-half or less of the circumference of the roll. Also, by having three or more positions for biasing the blanket roll 10 downward, the uniformity of the distribution in the axial center direction of the pressure that acts on the blanket roll 10 may be increased.

In accordance with the transfer characteristic of the ink from the plate 3 to the blanket roll 10, and the transfer characteristic of the ink from the blanket roll 10 to the substrate 5 serving as the print target, the contact pressure between the blanket roll 10 and the plate 3 or substrate 5 may be made the same.

In the aforementioned embodiments, when performing the transfer operation in the transfer mechanism portion 9, the description was given of defining the table position with the end portion of the plate table 4 and the substrate table 6 approaching the other end of the guide rails 2 in the longitudinal direction (the right end portion in the drawings) serving as a reference, but the reference for defining the table position of each table 4 and 6 may be set to an arbitrary position of each table 4 and 6.

Provided the inking apparatus 17 is capable of performing appropriate inking to the plate 3 that is held on the plate table 4, an inking apparatus 17 with any shape other than that shown in FIGS. 10A to C and FIGS. 11A and B may be used.

Providing the alignment area 37 is preferable from the standpoint of automatically taking alignment, but if it is possible to take alignment of the plate that is held on the plate table 4 and the substrate 5 that is held on the substrate table 6 by another means, the alignment area 37 may be omitted.

Hereinbelow, still another embodiment for implementing the present invention shall be described with reference to the drawings.

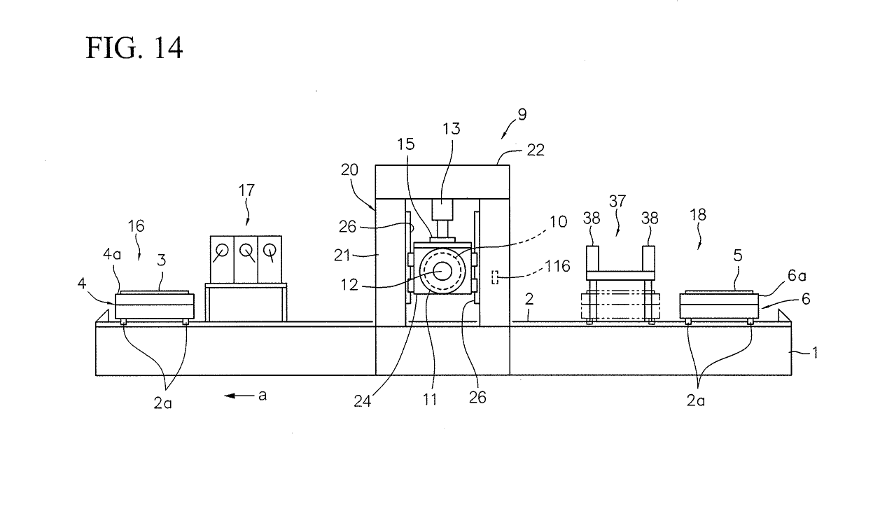

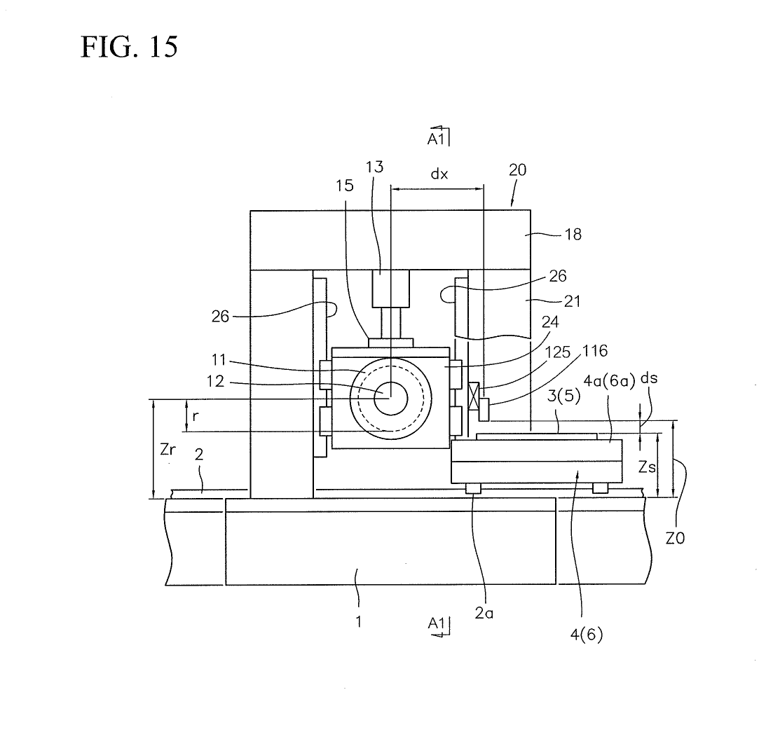

FIG. 14 through FIG. 24 show still another embodiment of the offset printing method and apparatus of the present invention, and have the following constitution. Note that in the following description, those members that have the same constitution as the members described in the aforementioned FIG. 1 to FIG. 13 are denoted by the same reference numerals as the members described in the aforementioned FIG. 1 to FIG. 13, and descriptions thereof are omitted.

In the present embodiment, when respectively performing the transfer (reception) process from the plate 3 that is held on the plate table 4 to the blanket roll 10, and the retransfer (printing) process from the blanket roll 10 to the substrate 5 that is held on the substrate table 6 in the transfer mechanism portion 9, a distance measurement sensor 116 is provided so as to face downward at a required height of positions that are removed by a required dimension from the blanket roll 10 toward the upstream side in the travel direction (shown by the arrow a in the drawings. Hereinbelow, simply referred to as the table travel direction during transfer) when the tables 4 and 6 are travelled along the movement direction of the lower end portion of the peripheral wall surface of the blanket roll 10 that is rotated (rotationally driven) by a rotational drive motor 11. Then, it becomes possible to measure with the distance measurement sensors 116 the distance to the surface of the plate 3 that is held on the plate table 4 and the substrate 5 that is held on the print target table 6 that pass thereunder.

Furthermore, in the present embodiment, the controller 19 issues commands to the individual drive units 7 of the plate table 4 and the substrate table 6, and the drive motor 11 and the lift actuator 13 of the blanket roll 10 of the transfer mechanism portion 9, based on the detection signal of the position of the plate table 4 and the substrate table 6 in relation to the longitudinal direction (X-axis direction) of the guide rails 2 inputted by the linear scale 8, and the signals that are inputted by the encoder 12, the height sensor 14 and the pressure sensor 15 of the transfer mechanism portion 9, and the signal inputted by the distance measurement sensor 116.

Furthermore, due to the detection of the vertical direction position of a roll housing 24 by the height sensor 14, it is possible to indirectly perform detection of the height (hereinbelow referred to as the roll height) Zr of the rotational axis of the blanket roll 10 with the upper surface of the trestle 1 serving as a reference. Thereby, in the state of the blanket roll 10 being arranged so that the roll height Zr that is detected by the height sensor 14 agrees with the predetermined retraction height Ha, by lifting the blanket roll 10 integrally with the roll housing 24 along the linear guides 26 by synchronized operation of each lift actuator 13, it is possible to make the plate table 4 that holds the plate 3 and the substrate table 6 that holds the substrate 5 pass beneath along the guide rails 2 without interfering with the blanket roll 10.

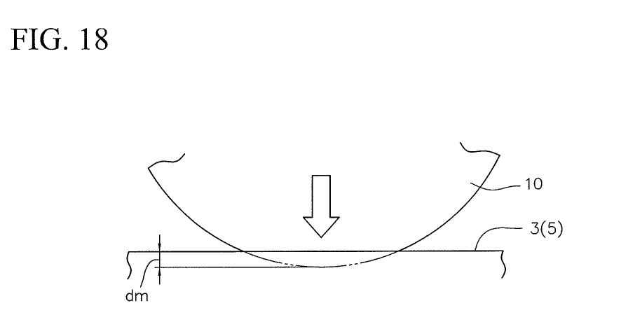

Also, when the plate 3 that is held on the plate table 4 and the substrate 5 that is held on the substrate table 6 are arranged directly under the blanket roll 10, it becomes possible to lower the blanket roll 10 integrally with the roll housing 24 by synchronized operation of each lift actuator 13 until a position at which the roll height Zr of the blanket roll 10 that is detected by the height sensor 14 becomes lower by a dimension corresponding to the target roll pressing amount (the target crush allowance of the surface portion of the blanket roll 10) dm than the height of the roll rotational center when the lower end portion of the peripheral wall surface of the blanket roll 10 makes contact with the surface of the plate 3 on the plate table 4 or the substrate 5 on the substrate table 6. That is, as shown in FIG. 18, it is possible to produce a printing pressure that corresponds to the pressure that is required for deforming the surface portion of the peripheral wall of the blanket roll 10 to the target roll pressing amount dm, by pressing the blanket roll 10 against the plate 3 or substrate 5 on the tables 4 and 6, respectively. Furthermore, during this procedure, it is possible to measure the aforementioned printing pressure of the blanket roll 10 against the plate 3 on the plate table 4 or the substrate 5 on the substrate table 6 by the pressure sensors 15 that are provided in series with each lift actuator 13 as reaction force of the force of each lift actuator 13 biasing the blanket roll 10 downward integrally with the roll housing 24.

The distance measurement sensor 116 is arranged so as to face downward at positions removed by a predetermined distance dx from the rotational center of the blanket roll 10 in the transfer mechanism portion 9 toward the upstream side in the table travel direction a during transfer, and at two positions of a required height that become directly above positions toward both end portions in the width direction of the plate 3 that is held on the plate table 4 and the substrate 5 that is held on the substrate table 6. Each distance measurement sensor 116 is fixed via an attachment member 125 that extends in the lateral direction to two pillar members 21 that are positioned on the upstream side in the table travel direction a during transfer in the frame 20 of the transfer mechanism portion 9. Thereby, the sensor height Z0 of each distance measurement sensor 116 with the surface of the trestle 1 serving as a reference is made a known, fixed value. Also, it is possible to measure the distance ds in the vertical direction from each distance measurement sensor 116 to the surface of the plate 3 or substrate 5 that is held on the plate table 4 or the substrate table 6 positioned direction below, at the stage prior to the plate table 4 that holds the plate 3 or the substrate table 6 that holds the substrate 5 that travel along the table travel direction a during transfer advancing to directly below the blanket roll 10.

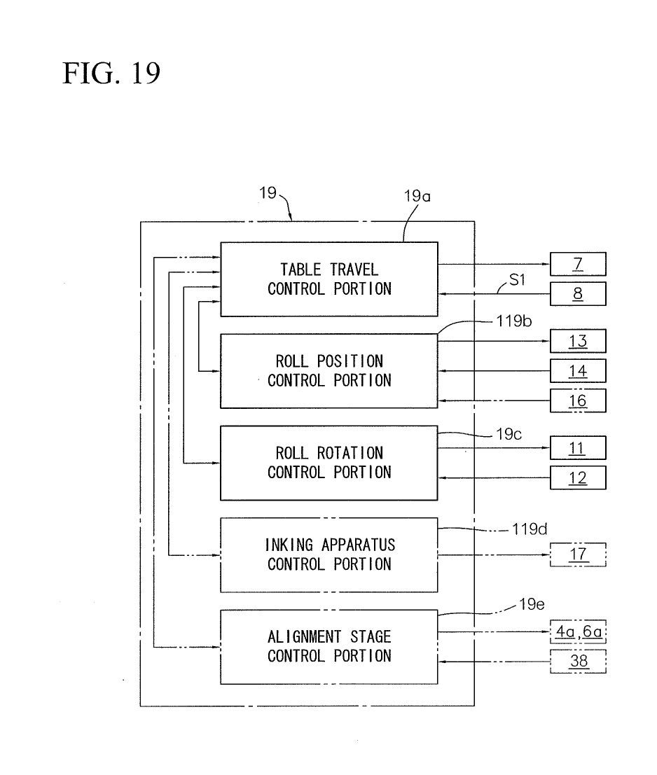

The controller 19 is provided with a table travel control portion 19a, a roll position control portion 119b, and a roll rotation control portion 19c, as shown by the control constitution in FIG. 19. The table travel control portion 19a controls the positions, the movement direction (travel direction) and movement speed (travel velocity) of the tables 4 and 6 by issuing commands to the individual drive units 7 of the plate table 4 and the substrate table 6, based on individual table position detection signals S1 of the plate table 4 and the substrate table 6 that are input from the linear scale 8 that is provided on the trestle 1. The roll position control portion 119b controls the roll height Zr of the blanket roll 10 by issuing commands to each lift actuator 13 of the blanket roll 10, based on the detection signal of the roll height Zr of the blanket roll 10 that is input from each height sensor 14 in the transfer mechanism portion 9, and the detection signal of the distance ds from each distance measurement sensor 116 to the plate 3 or substrate 5 on the plate table 4 or substrate table 6 positioned directly below, that is input by each distance measurement sensor 116. The roll rotation control portion 19c controls the rotation speed and the rotation angle of the blanket roll 10 by issuing commands to the drive motor 11 of the blanket roll 10, based on the detection signal of the rotation speed and the rotation angle of the blanket roll that is input from the encoder 12 that is attached to the drive motor 11 of the blanket roll 10. Furthermore, it is possible to control the roll position control portion 119b and the roll rotation control portion 19c in synch with the table travel control portion 19a.

Here, the method of deriving the control target value in relation to the roll height Zr for performing height control of the blanket roll 10 in the controller 19 will be described.

When the measurement signal of the distance ds in the vertical direction from each distance measurement sensor 116 to the surface of the plate 3 or substrate 5 that is held on the plate table 4 or substrate table 6 that is positioned directly below thereof is input to the controller 19 by each distance measurement sensor 116, the controller 19 calculates the surface height Zs (Zs=Z0−ds) based on the upper surface of the trestle 1 for the portion of the plate 3 or substrate 5 that is positioned directly below each distance measurement sensor 116 at that time, by subtracting the distance ds from the sensor height Z0 of each distance measurement sensor 116 that refers the upper surface of the trestle 1 that is a known fixed value as a reference.

However, each distance measurement sensor 116 is installed at a position that is separated by a distance dx in the horizontal direction to the upstream side in the table travel direction a during transfer, with respect to the rotational center of the blanket roll 10. For that reason, in the case of the travel velocity in the table travel direction a during transfer of each table 4 and 6 being v, a time lag of dx/v arises in the portion of the plate 3 or substrate 5 for which calculation of the surface height Zs has been performed based on the upper surface of the trestle 1, that is, the portion that is positioned directly below each distance measurement sensor 16, reaching a position directly below the rotation center of the blanket roll 10.

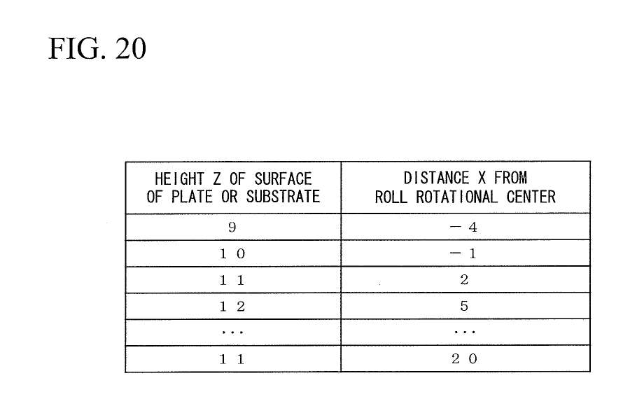

Therefore, when the controller 19 calculates the surface height Zs for the portion of the plate 3 or substrate 5 that is positioned directly below each distance measurement sensor 116 at that time, toward the upper surface of the trestle 1, based on the measurement signal of the distance ds that is input by each distance measurement sensor 116 as described above, in a predetermined measurement cycle, that value is sequentially stored in relation to the horizontal direction distance (x) from the roll rotational center of the blanket roll, in a surface height temporary table as shown in FIG. 20. At that time, the value of the measurement value of the surface height Zs of the plate 3 or substrate 5 that is newly stored just after measurement in the aforementioned measurement cycle, as shown in the lowermost line in the table of FIG. 20, is stored in association with the value corresponding to the horizontal direction distance dx between the rotational center of the blanket roll 10 and each distance measurement sensor 16 as the maximum value from the aforementioned roll rotation center in the horizontal direction distance (x) (for example, 20 mm in the case of FIG. 20).

Then, the position where calculation of the surface height Zs is performed at the plate 3 or substrate 5 in the aforementioned predetermined measurement cycle moves in the table travel direction a during transfer over the passage of time. For that reason, the controller 19 sequentially updates the value of (x) in the right column of the table of FIG. 20 by subtracting the value of (control cycle) x (travel velocity v of each table 4 and 6) at each required control cycle for performing control of the roll height Zr of the blanket roll 10 as described below.

Accordingly, the value of the surface height Zs of the plate 3 or substrate 5 of the left column of the table when the value (x) of the distance from the roll rotation center in the right column of the table of FIG. 20 becomes zero shows the surface height Zs of the portion at the plate 3 or substrate 5 that is positioned directly below the rotational center of the blanket roll 10 at that time.

Note that in the case of the aforementioned control cycle not agreeing the aforementioned measurement cycle, such the aforementioned control cycle being set to a time interval that is shorter than the aforementioned measurement cycle or the like, as shown in FIG. 20, the value of the right column of the table in the surface height temporary storage table may not become zero. In that case, the controller 19 calculates the surface height Zs of the portion at the plate 3 or substrate 5 that is positioned directly below the rotational center of the blanket roll 10 at that time by taking the internal division of the values of the left column of the table of the two rows in which the values of the distance (x) from the roll rotational center in the right column of the table of FIG. 7 sandwich zero.

Specifically, for example, according to the table of FIG. 20, the data of the surface height of 10 mm at the distance of −1 mm from the roll rotation center, and the data of the surface height 11 mm at the distance of 2 mm from the roll rotation center are used. Then, by taking the internal division of both (10×⅔+11×⅓), the value 10.3 is calculated as the surface height Zs of the portion of the plate 3 or substrate 5 that is positioned directly under the rotation center of the blanket roll 10.

Note that in the surface height temporary storage table that is shown in FIG. 20, since minus values of the distance (x) values from the roll rotation center in the right column are unnecessary data other than those that are just proximal to zero, memory may be sequentially freed up. Also, unnecessary data may be sequentially overwritten in the manner of using a ring buffer.

As described above, when the surface height Zs of the portion of the plate 3 or substrate 5 that is positioned directly under the rotation center of the blanket roll 10 is found, the controller 19 calculates the control target value Zr0 (Zr0=Zs+r−dm) of the roll height Zr by adding the radius r, from the rotational center of the blanket roll 10 to the lower end portion of the peripheral wall surface, to that value, and furthermore subtracting the value of the target roll pressing amount dm that corresponds to the crush allowance of the surface portion of the blanket roll 10 that is required in order to obtain the desired printing pressure.

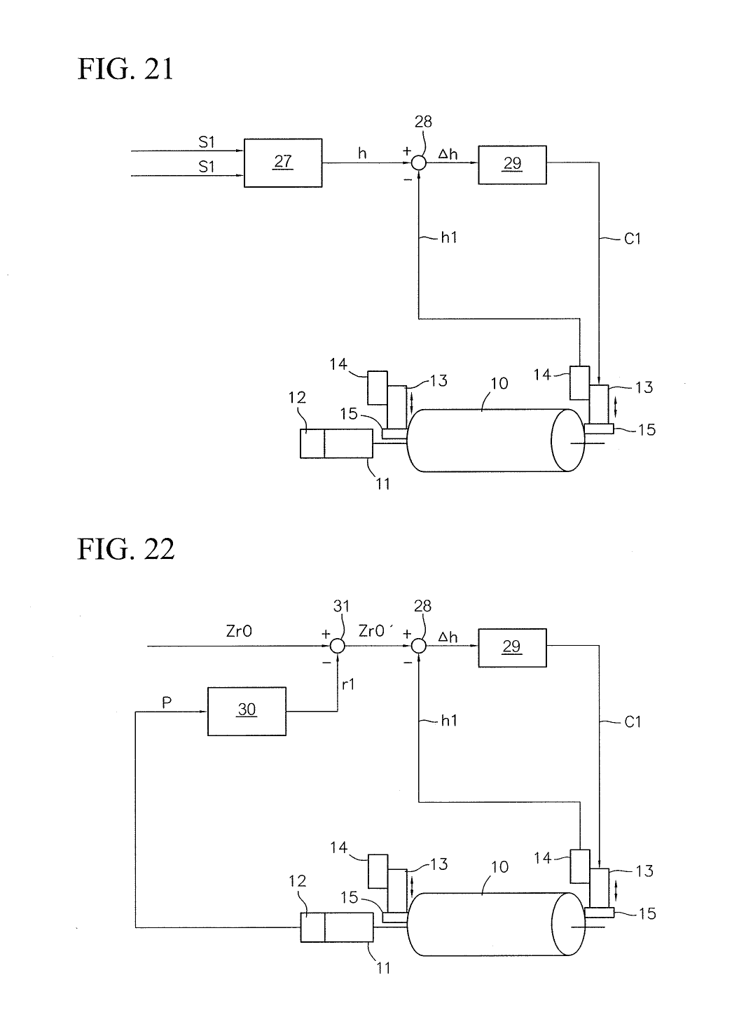

FIG. 21 and FIG. 22 show control block diagrams of the roll height control function by the controller 19. FIG. 21 shows the height control function in the case of the blanket roll 10 being brought into contact with the plate 3 or substrate 5, and FIG. 22 shows the height control function in the case of making the printing pressure uniform when performing the transfer (reception) process by bringing the blanket roll 10 into contact with the plate 3, and when performing the retransfer (printing) process by bringing the blanket roll 10 into contact with the substrate 5. Note that in FIG. 21 and FIG. 22, for the sake of convenience, descriptions of the frame 20 of the transfer mechanism portion 9 and the roll housing 24 of the blanket roll 10, and the control system of the lift actuator 13 on one side of the blanket roll 10 are omitted. Also, the shape and arrangement of the drive motor 11, the encoder 12, the lift actuator 13, the height sensor 14, and the pressure sensor 15 that are attached to the blanket roll 10 are modified.

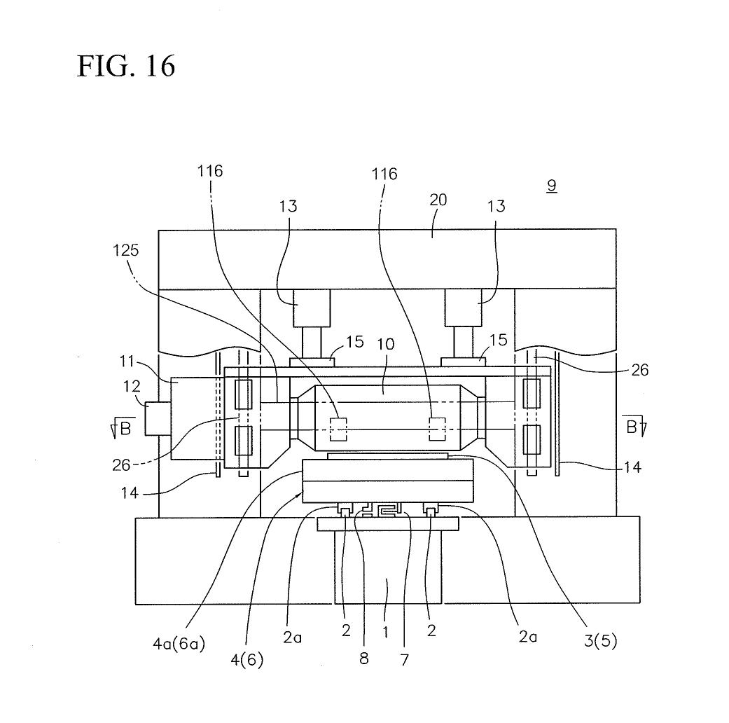

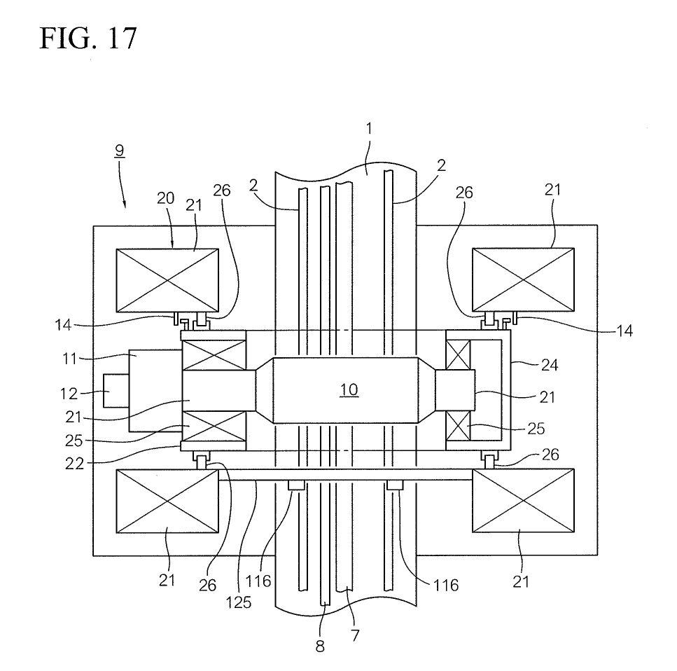

The roll height control function in the case that the blanket roll 10 is not contacted with the plate or substrate 5 by the controller 19 is as follows. That is, as shown in FIG. 21, when a table position detection signal S1 relating to the position in the X-axis direction of the plate table 4 and the position in the X-axis direction of the substrate table 6 according to the linear scale 8 on the trestle 1 (refer to FIG. 16 and FIG. 17) is input, the controller 19, by performing a table function process 27 by a required table function that is set in advance based on each table position detection signal S1, determines whether the blanket roller 10 should be arranged at the retraction height Ha, or at the retraction height Hb at which the blanket roll 10 makes contact with the plate 3 or the substrate 5 held on the plate table 4 or the substrate table 6, and outputs the height target value h of the retraction height Ha or the contact vicinity height Hb. Next, the height target value h and the height current value h1 of the blanket roll 10 based on the detection signal input from the height sensor 14 of the transfer mechanism portion 9 are input to the subtractor 28 to find the height deviation Δh of the height current value h1 with respect to the height target value h, and thereafter the drive command C1 that is found by performing the feedback process 29 based on feedback control theory such as PID control for making this height deviation Δh zero is issued to the lift actuators 13 of the blanket roll 10.

In this way, by operating the lift actuators 13 based on the drive command C1, in accordance with the position of the plate table 4 or the substrate table 6 in the X-axial direction, it is possible to arrange the blanket roll 10 at the contact height Hb in the case of initiating contact of the blanket roll 10 with the plate 3 or substrate 5 as described below, or otherwise arrange the blanket roll 10 at the retraction height Ha.

Next, the height control function by the controller 19 in the case of making the printing pressure of the blanket roll 10 uniform with respect to the plate 3 or the substrate 5 shall be described with FIG. 22.

That is, when the control target value Zr0 (Zr0=Zs+r−dm) of the roll height Zr is calculated by the controller 19 as mentioned above, the controller 19, in the same manner as the height target value h of FIG. 21, inputs that value to the subtractor 28 to find the height deviation Δh with respect to the roll height control target value Zr0 of the height current value h1 of the blanket roll 10 based on the detection signal that is input from the height sensor 14 of the transfer mechanism portion 9, and thereafter the drive command C1 that is found by performing the feedback process 29 based on feedback control theory such as PID control for making this height deviation Δh to zero is issued to the lift actuators 13 of the blanket roll 10.

In this way, by operating the lift actuators 13 based on the drive command C1, when the plate 3 or the substrate 5, which are held on the plate table 4 and the substrate table 6, are arranged just below the blanket roll 10, the blanket roll 10 is arranged so that the roll height Zr thereof agrees with the control target value Zr0, and thereby by pressing the blanket roll 10 with the target roll pressing amount dm against the plate 3 or substrate 5 which are arranged just below, it is possible to generate the desired printing pressure.

In the aforementioned, in the case of performing transfer (reception) of ink from the plate 3 to the blanket roll 10, it is necessary to stick the ink that has been inked on the plate 3 to the surface of the blanket roll 10. On the other hand, in the case of retransferring the ink from the blanket roll 10 to the substrate 5 that serves as the print target, it is necessary to stick the ink that is stuck to the surface of the blanket roll 10 to the surface of the substrate 5 by being detached from the surface of the blanket roll 10. For that reason, the transfer characteristics of the ink from the plate 3 to a blanket roll 10, and the transfer characteristics of the ink from the blanket roll 10 to the substrate 5 are not necessarily the same. Moreover, in order to improve the transfer performance in the entire offset printing, the contact pressure that is desired when bringing the blanket roll 10 into contact with the plate 3, and the contact pressure that is desired when bringing the blanket roll 10 into contact with the substrate 5 are not necessarily the same.

Therefore, the target roll pressing amount dm that is desired or in accordance with the contact pressure is individually set by the controller 19 in accordance with the object of contact with the blanket roll 10 being either of the plate 3 or the substrate 5. Thereby, it is possible to obtain the target roll pressing amount dm in accordance with the plate 3 or the substrate 5 by changing the control target value Zr0 itself of the roll height that is input to the subtractor 28.

Furthermore, in the case of eccentricity occurring in the rotational center of the blanket roll 10 due to processing accuracy, during rotation of the blanket roll 10, a fluctuation occurs in the dimension of the roll radius r from the rotation center to the lower end portion of the peripheral wall surface due to that eccentricity. Therefore, by performing with the controller 19 a table function process 30 based on the aforementioned correction table that is found by measuring in advance the non-uniformity of the rotation angle and circumferential position of the blanket roll 10, based on a detection signal p of the encoder 12 that is attached to the drive motor 11 for rotation of the blanket roll 10, an eccentricity correction value r1 of the circumferential position corresponding to the rotation angle of the blanket roll 10 is found. Also, after having corrected in advance the roll height control target value Zr0 using the eccentricity correction value r1 by another subtractor 31 at the point in time of having produced the desired printing pressure by pressing the blanket roll 10 with the target roll pressing amount dm against the plate 3 or substrate 5 which are arranged just below, the height deviation Δh of the height current value h1 with respect to the roll height control target value Zr0′ after this correction is found, and then the drive command C1 is found by performing the feedback process 29 for making this height deviation Δh to zero.

Furthermore, when producing the desired printing pressure by performing control of the roll height Zr as described above to press the blanket roll 10 with the target roll pressing amount dm against the plate 3 or substrate 5 that is arranged just below, by individually performing control of the two lift actuators 13 that are provided mostly in correspondence with both end portions in the axial center direction of the blanket roll 10 with the same procedure as described above, based on the detection signals by each distance measurement sensor 116 that is provided at two positions approaching both end portions in the width direction of the plate 3 and the substrate 5, it is possible to achieve equalization of the pressure distribution along the roll axis direction of the printing pressure of the blanket roll 10 with respect to the plate 3 or substrate 5.

Note that the offset printing apparatus of the present invention is provided, at a position that corresponds to one end portion of the guide rails 2 in the longitudinal direction on the trestle 1, with a plate table standby area 16 so as to move the plate table 4 to one end portion of the guide rails 2 in the longitudinal direction and place it in standby, and so as to perform exchange of the plate 3 that is held on the plate table 4. Also, it is provided with an inking apparatus 17 for performing inking of the plate 3 that is held on the plate table 4, at a position between the plate table standby area 16 and the transfer mechanism portion 9. Furthermore, it is provided, at a position that corresponds to the other end portion of the guide rails 2 in the longitudinal direction on the trestle 1, with a substrate installation area 18 for performing attachment of a new substrate 5 on the substrate table 6 and removal of the substrate 5 after printing, in the state of the substrate table 6 being moved to the other end portion in the longitudinal direction of the guide rails 2.

Furthermore, in the offset printing apparatus that is shown in FIG. 14, the plate table 4 and the substrate table 6 are respective provided on the upper portion thereof with an alignment stage 4a and 6a in which horizontal movement in a direction (Y-axis direction) perpendicular with the longitudinal direction of the guide rails 2 (X-axis direction), and yaw angle (θ) rotation with respect to the longitudinal direction of the guide rails 2 are possible. It is possible to attach the plate 3 and the substrate 5, which is the print target, to the upper surface portion of the alignment stage 4a and 6a, respectively.

Moreover, the alignment area 37 is provided between the transfer mechanism portion 9 and the substrate installation area 18 on the trestle 1. Then, it is possible to take initial alignment of the plate 3 that is held on the alignment stage 4a of the plate table 4 and the substrate 5 that is held on the alignment stage 6a of the substrate table 6, using the common alignment sensor 38 such as a precision camera 38 or the like.

Note that, as shown by the chain double-dashed line in FIG. 19, the inking apparatus control portion 119d for controlling the inking operation in the inking apparatus 32 may be provided in the controller 19. Also, the alignment stage control portion 19e that controls the operation for taking the initial alignment of the plate 3 and the substrate 5 by the alignment stages 4a and 6a of the tables 4 and 6 in the alignment area 34 may be provided in the controller 19. In this case, the inking apparatus control portion 119d and the alignment stage control portion 19e may be made to perform synchronized control with the table travel control portion 19a.

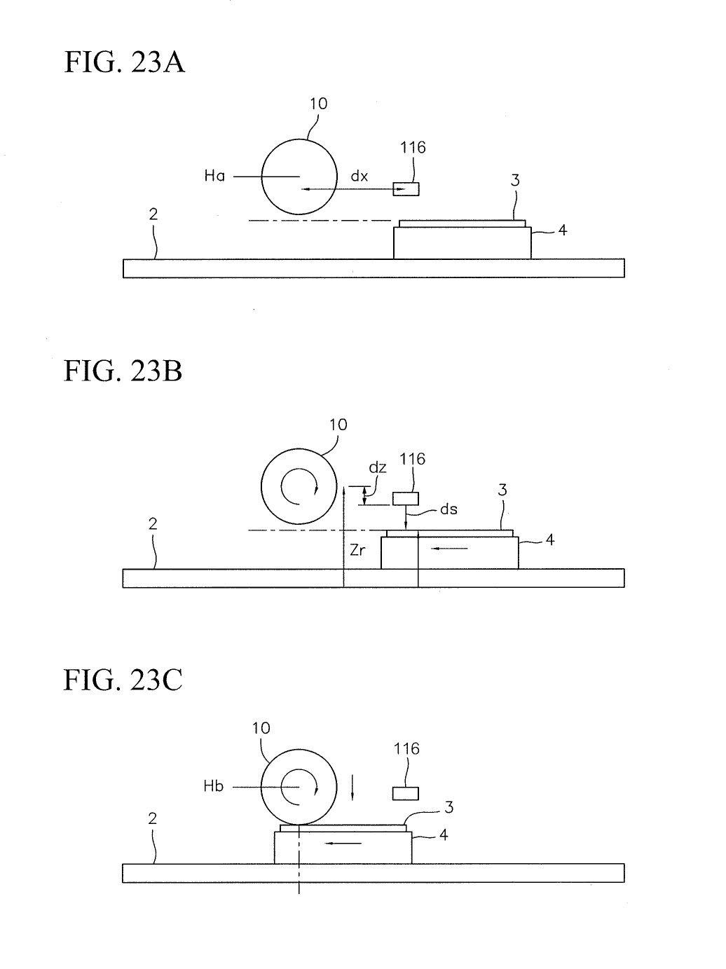

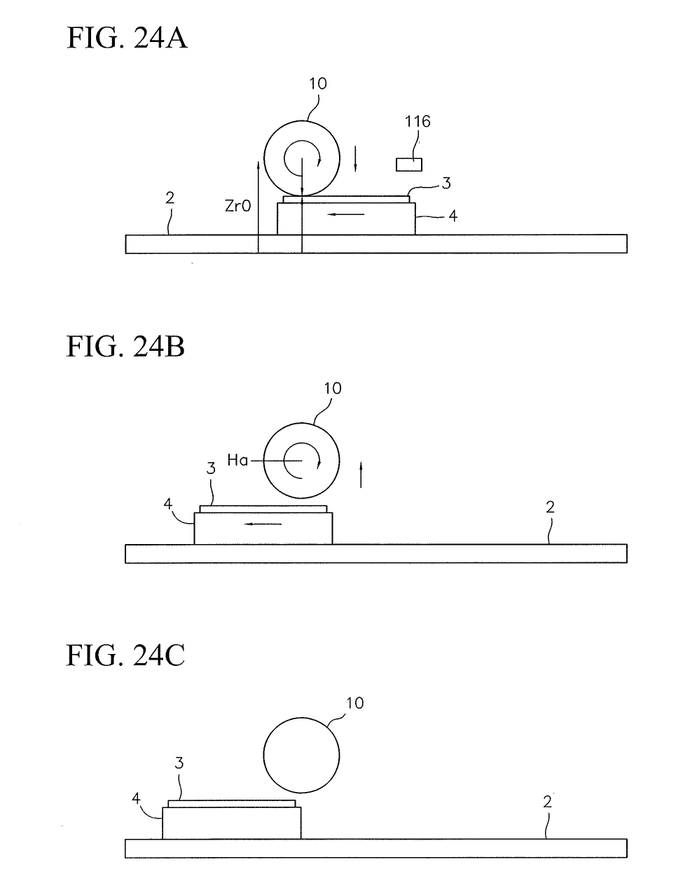

In the case of performing offset printing using the offset printing apparatus of the present invention that is provided with the controller 19 that is provided with the height control function for the blanket roll 10 in the above manner, the procedure of the transfer operation of the transfer (reception) process of ink from the plate 3 to the blanket roll 10 in the transfer mechanism portion 9 is performed by the procedure shown in FIG. 23A to FIG. 24C.

Note that in the aforementioned drawings, the rotation direction of the blanket roll 10 during transfer is made to be the clockwise direction, and the travel direction for transfer of the plate table 4 is made to head from the other end side on the longitudinal direction of the guide rails 2 to the one end side (leftward).

In the case of performing the transfer operation from the plate 3 to the blanket roll 10, the blanket roll 10 is arranged in advance at the retraction height Ha as shown in FIG. 23A, using the height control function of the blanket roll 10 that is shown in FIG. 8. Note that at this point in time, the rotation of the blanket roll 10 is stopped. Also, in the state of the inking being carried out in advance by the inking apparatus 17 on the plate 3 that is held on the plate table 4 (refer to FIG. 1), the plate table 4 is arranged and once made to stop at the transfer start position that is set in advance more on the upstream side in the table travel direction a during transfer than just under the rotation center of the blanket roll 10. Note that in the drawings, the table position is set with the end portion of the plate table 4 toward the other end of the guide rails 2 in the longitudinal direction (the right end portion in the drawings) serving as a reference.

Next, as shown in FIG. 23B, the blanket roll 10 is made to rotate by operation of the drive motor 11 in the state of being arranged at the retraction height Ha. Also, the plate table 4, which has been stopped at the transfer start position X0, is made to travel in the table travel direction a during transfer by operation of the drive apparatus 7 (refer to FIG. 16 and FIG. 17). At this time, the circumferential velocity of the blanket roll 10 based on its roll diameter in the state of the blanket roll 10 having deformed at the contact portion with the plate 3 by contacting the blanket roll 10 with the plate 3 by the target roll pressing amount dm that is set in advance, and the travel speed of the plate table 4 are synchronized. Furthermore, regarding the circumferential position based on the roll diameter in the state of having deformed the blanket roll 10 at the contact portion with the plate 3, phase synchronization control is performed so that the contact position with the plate 3 becomes the predetermined position.

Next, at the point in time when the plate 3 on the plate table 4 that travels in the table travel direction a during transfer has reached just below each distance measurement sensor 116, the measurement of the height of the surface of the plate 3 is made to start by a predetermined measurement cycle by the distance measurement sensors 116.

Thereafter, as shown in FIG. 23C, at the point in time in which the plate 3 on the plate table 4 has proceeded by a required amount directly under the blanket roll 10, the controller 19, using the height control function of the blanket roll 10 shown in FIG. 21, issues a drive command C1 for height control to each lift actuator 13 to lower the blanket roll 10 until the contact height Hb that is set in advance, and brings the lower end portion on the outer periphery of the blanket roll 10 into contact with the plate 3 that is held on the plate table 4. Note that in the case of an ink pool being formed at the end area of the plate 3 approaching the one end of the guide rails 2 in the longitudinal direction by performing inking on the plate 3 that is held on the plate table 4 in the inking apparatus 32, the contact position of the blanket roll 10 with respect to the plate 3 is set so that the blanket roll 10 does not make contact with this ink pool.

As described above, when the peripheral wall surface of the blanket roll 10 is brought into contact with the plate 3 on the plate table 4, the controller 19 performs a switch to the blanket roll 10 height control function as shown in FIG. 22.

Thereby, the blanket roll 10 is pressed against the plate 3 with the target roll pressing amount dm, as shown in FIG. 24A.

Then, the contact state of the blanket roll 10 with respect to the plate 3 by the target roll pressing amount dm is maintained, in accordance with changes in the surface height Zs of the plate 3 that is measured in advance by the distance measurement sensors 116.

Furthermore, at this time, even in the case of eccentricity existing in the blanket roll 10, the contact state of the blanket roll 10 with respect to the plate 3 by the target roll pressing amount dm is maintained while correcting that eccentricity.

Therefore, the target pressing amount is maintained while the blanket roll 10 is making contact with the plate 3. As a result, the printing pressure of the blanket roll 10 with respect to the plate 3 is uniformly maintained.

After the transfer from the plate 3 to the blanket roll 10 is completed, as shown in FIG. 24B, at the point in time of the plate table 4 reaching the required roller separation position that has been set prior to it completely passing directly under the blanket roll 10, the controller 19, by performing a switch to the height control function of the blanket roll 10 shown again in FIG. 21, issues a drive command C1 for height control to each of the lift actuators 13 in the state of the rotation of the blanket roll 10 and the travel of the plate table 4 being continued, to lift the blanket roll 10 to the retraction height Ha.

Note that after the blanket roll 10 has been lifted and separated from the plate 3 as described above, the synchronization control of the rotation speed of the blanket roll 10 and the travel speed of the plate table 4 may be released.

Then, as shown in FIG. 24C, when the plate table 4 travels to the predetermined transfer complete position, the controller 19 stops the rotation of the blanket roll 10 that has been lifted to the retraction height Ha, to restore it to the initial state similarly to that shown in FIG. 23A.

In the case of performing the retransfer (printing) process of ink from the blanket roll 10 to the substrate 5 that is the print target after having performed the transfer (reception) process of the ink from the plate 3 to the blanket roll 10 in the transfer mechanism portion 9 as described above, using the substrate table 6 that holds the substrate 5 serving as a print target instead of the plate table 4 that holds the plate 3, by performing the transfer operation with the same procedure as FIG. 23A to FIG. 24C by the controller 19, it is possible to perform retransfer (printing) of ink from the blanket roll 10 to the substrate 5.

In this way, according to the offset printing method and apparatus of the present invention, it is possible to always press the blanket roll 10 against the plate 3 that is held on the plate table 4 or the substrate 5 that is held on the substrate table 6 with a pressing amount that corresponds to the target roll pressing amount d that is set in advance. For that reason, in the case of the thickness dimension of the plate 3 and the substrate 5 differing, the thickness of the substrate 5 differing for each lot, and the thickness dimension of the substrate 5 not necessarily being uniform even within the same lot, and furthermore even in the case of eccentricity existing in the blanket roll 10 due to processing accuracy, it is possible to uniformly maintain the respective printing pressure while performing the transfer (reception) process by bringing the blanket roll 10 into contact with the plate 3, and while performing the retransfer (printing) process by bringing the blanket roll 10 into contact with the substrate 5.

Therefore, it is possible to increase the printing accuracy of the printing pattern that is printed from the plate 3 to the substrate 5, which is the print target, via the blanket roll 10, and as a result it is possible to perform fine printing such as of an electrode pattern with high accuracy.

Moreover, in order to uniformly maintain the printing pressure of the blanket roll 10 with respect to the plate 3 or substrate 5, control of the blanket roll 10 that is performed so as to become the target roll pressing amount dm, is performed based on the measurement signal of the surface height Zs of the plate 3 or substrate 5 that is measured by each distance measurement sensor 116, at the point in time of the plate 3 on the plate table 4 or the substrate 5 on the substrate table 6 being arranged to the upstream side more than the rotation center of the blanket roll 10 in the table travel direction a during transfer. For that reason, it is possible to prevent a delay in the response time, which is advantageous in the case of performing printing at a high speed while evenly controlling the printing pressure.

Note that the present invention is not limited to only the aforementioned embodiments. For example, when the installation position of the distance measurement sensors 116 (the distance dx in the horizontal direction from the rotational center of the blanket roll 10) is shifted to the upstream side in the table travel direction a during transfer from the rotation center of the blanket roll 10, it may be appropriately changed in accordance with the travel speed of the plate table 4 and the substrate table 6, and the reaction velocity of the lift actuators 13 of the blanket roll 10.

In the embodiments shown in FIG. 14 to FIG. 24C, there is shown the case of constitution that fixes the distance measurement sensors 116 via the attachment member 125 to the two pillar members 21 that are positioned on the upstream side in the table travel direction a during transfer in the frame 20 of the transfer mechanism portion 9. However, the distance measurement sensors 116 may also be attached to the upstream side end portion in the table travel direction a during transfer in the roll housing 22.

In the case of this constitution, the height of the distance measurement sensors 116 changes in association with a vertical motion of the blanket roller 10. However, as shown in FIG. 23B, the difference dz between the roller center height Zr and the sensor height is fixed (fixed value).

Accordingly, in the case of the controller 19 calculating the surface height Zs of the portion of the plate 3 or substrate 5 that is positioned directly below the distance measurement sensors 116 based on the upper surface of the trestle 1, when the measurement signal of the distance ds in the vertical direction from the distance measurement sensor 116 to the surface of the plate 3 or substrate 5 that is held on the plate table 4 or the substrate table 6 that is positioned direction below is input from the distance measurement sensor 116, the surface height Zs (Zs=Zr−dz−ds) for the portion of the plate 3 or substrate 5 that is positioned directly below each distance measurement sensor 116 with the surface of the trestle 1 as a basis may be calculated at that time by subtracting the difference dz between the roll center height Zr and the sensor height, which is the aforementioned fixed value, and the distance ds from the roll center height Zr during the distance measurement.

Also, the arrangement interval in the width direction of the distance measurement sensors 116 may be suitably changed in accordance with the width dimension of the plate 3 and substrate 5.

Furthermore, there may be one distance measurement sensor 116 that is provided in the width direction of the plate 3 and the substrate 5. In this case, it is possible to control the height of the blanket roll 10 so that the target roll pressing amount dm is obtained, following changes in the surface height of the plate 3 or substrate 5 in the direction along the table travel direction a during transfer.

Also, three distance measurement sensors 116 may be provided in a row in the width direction of the plate 3 or substrate 5. In this case, by taking the average value of the surface height Zs of the plate 3 or substrate 5 that is measured by each distance measurement sensor 116, or finding the incline in the surface height in the horizontal direction, the height of the blanket roll 10 may be controlled so that the printing pressure becomes as uniform as possible in correspondence to that.

The offset printing apparatus of the present invention may be provided in order to perform printing on a print target other than a substrate. In addition, it is of course possible to add various modifications within a scope that does not depart from the spirit of the present invention.

### INDUSTRIAL APPLICABILITY

As described above, according to the present invention, it is possible to provide an offset printing method and apparatus that can perform with high accuracy fine printing such as an electrode pattern, and can suppress to a micrometer order misalignment even in the case of overprinting.

### DESCRIPTION OF REFERENCE NUMERALS

1 trestle
2 guide rail
3 plate
4 plate table (moving table)
5 substrate (print target)
6 substrate table (print target table, moving table)
10 blanket roll
13 lift actuator
14 height sensor
15 pressure sensor
19 controller
116 distance measurement sensor

1. An offset printing method that, by bringing a blanket roll that moves up and down by lift actuators into contact from above with a plate that is held on a plate table that travels on guide rails provided on a trestle, and next by bringing the blanket roll into contact from above with a print target that is held on a print target table that travels on the guide rails, performs a transfer from the plate to the blanket roll, and a retransfer from the blanket roll to the print target, wherein the offset printing method controls a vertical motion of the blanket roll by the lift actuators so that the contact pressure while the blanket roll makes contact with the plate that is held on the plate table, and the contact pressure while the blanket roll makes contact with the print target that is held on the print target table are respectively kept constant at a predetermined value.

2. An offset printing method that, by bringing a blanket roll that moves up and down by lift actuators into contact from above with a plate that is held on a plate table that travels on guide rails provided on a trestle, and next by bringing the blanket roll into contact from above with a print target that is held on a print target table that travels on the guide rails, performs a transfer from the plate to the blanket roll, and a retransfer from the blanket roll to the print target, wherein the offset printing method, after controlling a vertical motion of the blanket roll by the lift actuators so that the contact pressure when the blanket roll starts to make contact with the plate that is held on the plate table becomes a predetermined value, keeps the height of the blanket roll constant while the blanket roll is in contact with the plate that is held on the plate table, and moreover, after controlling the vertical motion of the blanket roll by the lift actuators so that the contact pressure when the blanket roll starts to make contact with the print target that is held on the print target table becomes a predetermined value, keeps the height of the blanket roll constant while the blanket roll is in contact with the print target that is held on the print target table.

3. An offset printing apparatus that is provided with a plate table and a print target table that travel on guide rails provided on a trestle and that, by successively bringing a blanket roll that moves up and down by lift actuators into contact from above with a plate that is held on the plate table and a print target that is held on the print target table, performs transfer from the plate to the blanket roll, and retransfer from the blanket roll to the print target, wherein the offset printing apparatus is provided with a pressure sensor that detects the contact pressure of the blanket roll that is moves up and down by the lift actuators with respect to the plate and the print target, and moreover provided with a controller that has a function that issues commands to the lift actuators so that while performing transfer between the blanket roll and the plate, and while performing retransfer between the blanket roll and the print target, the contact pressure that is respectively input from the pressure sensor is kept constant at a predetermined value.

4. An offset printing apparatus that is provided with a plate table and a print target table that travel on guide rails provided on a trestle and that, by successively bringing a blanket roll that moves up and down by lift actuators into contact from above with a plate that is held on the plate table and a print target that is held on the print target table, performs transfer from the plate to the blanket roll, and retransfer from the blanket roll to the print target, wherein the offset printing apparatus is provided with a height sensor that detects the height of the blanket roll that moves up and down by the lift actuators, and a pressure sensor that detects the contact pressure of the blanket roll with respect to the plate and the print target, and moreover, provided with a controller that has a function that issues commands to the lift actuators so that, when starting transfer between the blanket roll and the plate, the contact pressure that is input from the pressure sensor becomes a predetermined value, and issues commands to the lift actuators based on the input from the height sensor so that the height of the blanket roll when the contact pressure that has been input from the pressure sensor has become a predetermined value is maintained while performing transfer between the blanket roll and the plate, and a function that issues commands to the lift actuators so that, when starting retransfer between the blanket roll and the print target, the contact pressure that is input from the pressure sensor becomes a predetermined value, and issues commands to the lift actuators based on the input from the height sensor so that the height of the blanket roll when the contact pressure that has been input from the pressure sensor has become a predetermined value is maintained while performing retransfer between the blanket roll and the print target.

5. The offset printing apparatus according to claim 4, wherein the controller has a function that, in the case of eccentricity having arisen in the blanket roll when issuing commands to the lift actuators based on the input from the height sensor so that the height of the blanket roll when the contact pressure that has been input from the pressure sensor has become the respective predetermined value is maintained while performing transfer between the blanket roll and the plate, and while performing transfer between the blanket roll and the print target, adds a correction to the height that the blanket roll should be maintained at based on the eccentricity amount of the blanket roll.

6. An offset printing method that, by bringing a blanket roll that moves up and down by lift actuators, in the state of being rotated by a rotation drive motor, into contact from above with a plate that is held on a moving table that travels on guide rails on a trestle, and next by bringing the blanket roll into contact from above with a print target that is held on a moving table that travels on the guide rails, performs a transfer from the plate to the blanket roll, and a retransfer from the blanket roll to the print target, wherein the offset printing method, prior to the plate on the plate table or the print target on the print target table advancing to directly below the blanket roll, measures in advance the height of the surface of the plate on the plate table or the print target on the print target table with the upper surface of the trestle serving as a reference along the travel direction of the table during transfer, and next, when bringing the blanket roll into contact with the plate or the print target, controls the height on the trestle of the rotational center of the blanket roll to a height that is calculated by subtracting a predetermined target roll pressing amount from the sum of the height of the surface of the plate or print target that is measured in advance and the radius of the blanket roll.

7. An offset printing apparatus that, by successively bringing a blanket roll that moves up and down by lift actuators, in the state of being rotated by a rotation drive motor, into contact from above with a plate and a print target that are held on an individual or shared moving table that travels on guide rails on a trestle, performs a transfer from the plate to the blanket roll, and a retransfer from the blanket roll to the print target, wherein a distance measurement sensor for measuring the distance with the surface of the plate on the plate table or the print target on the print target table is provided more to the upstream side in the table travel direction during transfer than the blanket roll, and moreover the offset printing apparatus is provided with a controller that has a function that computes and temporarily stores the surface height of the portion of the plate on the plate table or the print target on the print target table that is positioned directly below the distance measurement sensor with the upper surface of the trestle serving as a reference, based on a signal that is input from the distance measurement sensor, and a function that, at the point in time of the portion being positioned directly below the rotational center of the blanket roll and making contact with the blanket roll, issues commands to the lift actuators to make the height of the rotational center of the blanket roll on the trestle agree with a height that is calculated by subtracting a predetermined target roll pressing amount from the sum of the height of the portion on the surface of the plate on the plate table or the print target on the print target table that is measured in advance and the radius of the blanket roll.
